(19) United States
(12) Patent Application Publication
(10) Pub. No.: US 2026/0141853 A1
(43) Pub. Date: May 21, 2026

(54) DISPLAY APPARATUS

(71) Applicant: LG Display Co., Ltd., Seoul (KR)

(72) Inventors: Soon-Sung AHN, Paju-si (KR); So-Hyun KIM, Paju-si (KR)

(73) Assignee: LG Display Co., Ltd., Seoul (KR)

(21) Appl. No.: 19/345,048

(22) Filed: Sep. 30, 2025

(30) Foreign Application Priority Data
Nov. 19, 2024 (KR) 10-2024-0165138

(51) Int. Cl. G09G 3/3233

(52) U.S. Cl. CPC G09G 3/3233; G09G 2300/043; G09G 2300/0819; G09G 2310/0245; G09G 2310/08; G09G 2320/0247; G09G 2330/022

(57) ABSTRACT

A display apparatus includes a light emitting diode, a driving transistor connected to an anode electrode of the light emitting diode at a first node, a first transistor connected between a second node and a fourth node, a second transistor connected between a data line and a fifth node, a third transistor connected to the first node and configured to receive an anode reset voltage, a fourth transistor connected to the fifth node and configured to receive a reference voltage, a first emission control transistor connected to the fourth node and configured to receive a high-potential driving voltage, and a second emission control transistor connected to the fourth node and connected to the driving transistor at a third node. The display apparatus can further include a first capacitor connected between the first and second nodes, and a second capacitor connected between the fourth and fifth nodes.

### CROSS REFERENCE TO RELATED APPLICATIONS

The present application claims priority to Korean Patent Application No. 10-2024-0165138, filed in Republic of Korea on Nov. 19, 2024, which is hereby expressly incorporated by reference in its entirety for all purposes as if fully set forth herein.

### BACKGROUND

### Field of the Invention

The present disclosure relates to a display apparatus.

### Discussion of the Related Art

As the information society develops various technologies, a demand for display apparatuses for displaying images have increased in various forms. In recent years, various flat display apparatuses such as organic light emitting display apparatuses and liquid crystal display apparatuses have been used.

In the organic light emitting display apparatus, in order to compensate for a threshold voltage of a driving transistor, a threshold voltage sampling is performed in a horizontal period when a data voltage is input.

In this case, since a sampling time for the threshold voltage compensation can be insufficient, an error component in the sampled voltage can exist, and thus the threshold voltage compensation in a pixel may not be performed sufficiently.

When the error in threshold voltage compensation occurs, the image quality of the display apparatus is deteriorated.

### SUMMARY OF THE DISCLOSURE

An advantage of the present disclosure is to provide a display apparatus that can increase a threshold voltage sampling time of a driving transistor and improve a threshold voltage compensation.

Additional features and advantages of the disclosure will be set forth in the description which follows, and in part will be apparent from the description, or can be learned by practice of the disclosure. These and other advantages of the disclosure will be realized and attained by the structure particularly pointed out in the written description and claims hereof as well as the appended drawings.

To achieve these and other advantages and in accordance with the purpose of the present disclosure, as embodied and broadly described herein, a display apparatus includes a display panel including a pixel; and a light emitting diode, and a plurality of transistors and first and second capacitors which are configured to be electrically connected to the light emitting diode, in the pixel, wherein the plurality of transistors include a driving transistor connected to an anode electrode of the light emitting diode at a first node; a first transistor connected between a second node (to which a gate electrode of the driving transistor is connected) and a fourth node; a second transistor connected between a data line and a fifth node; a third transistor connected to the first node and configured to receive an anode reset voltage; a fourth transistor connected to the fifth node and configured to receive a reference voltage; a first emission control transistor connected to the fourth node and configured to receive a high-potential driving voltage; and a second emission control transistor connected to the fourth node and connected to the driving transistor at a third node, wherein the first capacitor is connected between the first and second nodes, and the second capacitor is connected between the fourth and fifth nodes.

In another aspect of the present disclosure, a display apparatus includes a display panel including a pixel; a light emitting diode in the pixel; a driving transistor connected to an anode electrode of the light emitting diode at a first node; a first transistor connected between a second node (to which a gate electrode of the driving transistor is connected) and a fourth node; a second transistor connected between a data line and a fifth node; a third transistor connected to the first node and configured to receive an anode reset voltage; a fourth transistor connected to the fifth node and configured to receive a reference voltage; a first emission control transistor connected to the fourth node and connected to the driving transistor at a third node; a storage capacitor connected between the first and second nodes; and a pumping capacitor connected between the fourth and fifth nodes, wherein in a sampling period, the anode reset voltage and a threshold voltage of the driving transistor are configured to be sampled and reflected to the second node, and wherein in a data writing period after the sampling period, a data voltage is configured to be reflected to the second node.

It is to be understood that both the foregoing general description and the following detailed description are examples and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this disclosure, illustrate embodiments of the disclosure and together with the description serve to explain the principles of the disclosure. In the drawings:

FIG. 1 is a view schematically illustrating a display apparatus according to a first embodiment of the present disclosure;

FIG. 2 is a circuit view schematically illustrating an example of a pixel according to the first embodiment of the present disclosure;

FIG. 3 is a view illustrating a configuration of a gate driving portion of a display apparatus according to the first embodiment of the present disclosure;

FIG. 4 is a timing chart schematically illustrating an example of driving signals for driving a pixel according to the first embodiment of the present disclosure;

FIGS. 5 to 8 are views illustrating operating states of elements within a pixel in an initialization period, a sampling period, a data writing period, and an emission period, respectively, in driving using the driving signals of FIG. 4;

FIG. 9 is a timing chart schematically illustrating driving signals for driving a pixel according to a first modified example of the first embodiment of the present disclosure;

FIG. 10 is a timing diagram schematically illustrating driving signals for driving a pixel according to a second modified example of the first embodiment of the present disclosure;

FIG. 11 is a cross-sectional view schematically illustrating an example of a cross-sectional structure of a display panel according to the first embodiment of the present disclosure;

FIG. 12 is a timing chart schematically illustrating driving signals for driving a pixel according to a first example of a second embodiment of the present disclosure;

FIG. 13 is a view illustrating operating states of elements within a pixel in an anode reset period in driving using the driving signals of FIG. 12;

FIG. 14 is a timing chart schematically illustrating driving signals for driving a pixel according to a second example of the second embodiment of the present disclosure;

FIG. 15 is a view illustrating operating states of elements within a pixel in an anode reset period in driving using the driving signals of FIG. 14;

FIG. 16 is a timing view schematically illustrating driving signals for driving a pixel according to a third example of the second embodiment of the present disclosure;

FIG. 17 is a view illustrating operating states of elements within a pixel during an anode reset period in driving using the driving signals of FIG. 16;

FIG. 18 is a timing view schematically illustrating driving signals for driving a pixel according to a first example of a third embodiment of the present disclosure;

FIG. 19 is a view illustrating operating states of elements within a pixel during an emission-off period in driving using the driving signals of FIG. 18;

FIG. 20 is a timing chart schematically illustrating driving signals for driving a pixel according to a second example of the third embodiment of the present disclosure;

FIG. 21 is a view illustrating operating states of elements within a pixel in an emission-off period in driving using the driving signals of FIG. 20;

FIG. 22 is a timing chart schematically illustrating driving signals for driving a pixel according to a third example of the third embodiment of the present disclosure;

FIG. 23 is a view illustrating operating states of elements within a pixel in an emission-off period in driving using the driving signals of FIG. 22;

FIG. 24 is a view schematically illustrating an example of a pixel according to a fourth embodiment of the present disclosure;

FIGS. 25 to 28 are views illustrating operating states of elements within a pixel in an initialization period, a sampling period, a data writing period, and an emission period in driving according to the fourth embodiment of the present disclosure; and

FIG. 29 is a view schematically illustrating an example of a pixel according to a fifth embodiment of the present disclosure.

### DETAILED DESCRIPTION OF THE EMBODIMENTS

Advantages and features of the present disclosure and methods of achieving them will be apparent with reference to the embodiments described below in detail with the accompanying drawings. However, the present disclosure is not limited to the embodiments disclosed below, but can be realized in a variety of different forms, and only these embodiments allow the present disclosure to be complete. The present disclosure is provided to fully inform the scope of the disclosure to the skilled in the art of the present disclosure, and the present disclosure can be defined by the scope of the claims.

The shapes, sizes, proportions, angles, numbers, and the like disclosed in the drawings for explaining the embodiments of the present disclosure are illustrative, and the present disclosure is not limited to the illustrated matters. The same reference numerals refer to the same components throughout the description.

Furthermore, in describing the present disclosure, if it is determined that a detailed description of the related known technology unnecessarily obscure the subject matter of the present disclosure, the detailed description thereof can be omitted or briefly provided. When ‘comprising’, ‘including’, ‘having’, ‘consisting’, and the like are used in this disclosure, other parts can be added unless ‘only’ is used. When a component is expressed in the singular, cases including the plural are included unless specific statement is described.

In interpreting the components, even if there is no separate explicit description, it is interpreted as including a margin range.

In the case of a description of a positional relationship, for example, when the positional relationship of two parts is described as ‘on’, ‘over’, ‘above’, ‘below’, ‘beside’, ‘under’, and the like, one or more other parts can be positioned between such two parts unless ‘right’ or ‘directly’ is used.

In the case of a description of a temporal relationship, for example, when a temporal precedence is described as ‘after’, ‘following’, ‘before’, and the like, cases that are not continuous can be included unless ‘directly’ or ‘immediately’ is used.

In describing components of the present disclosure, terms such as first, second and the like can be used. These terms are only for distinguishing the components from other components, and an essence, order, sequence, or number of the components is not limited by the terms. Further, the term “can” fully encompasses all the meanings and coverages of the term “may” and vice versa.

Respective features of various embodiments of the present disclosure can be partially or wholly connected to or combined with each other and can be technically interlocked and driven variously, and respective embodiments can be independently implemented from each other or can be implemented together with a related relationship.

Hereinafter, embodiments of the present disclosure are described in detail with reference to the drawings. Meanwhile, in the following embodiments, the same and like reference numerals are assigned to the same and like components, and detailed descriptions thereof can be omitted or may be briefly provided. All the components of each display apparatus/device according to all embodiments of the present disclosure are operatively coupled and configured.

### First Embodiment

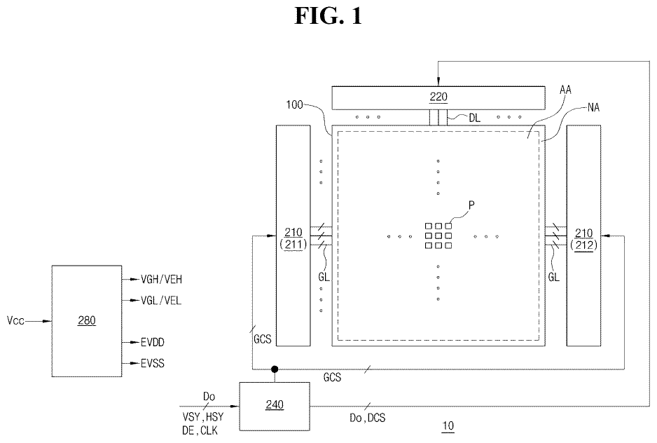

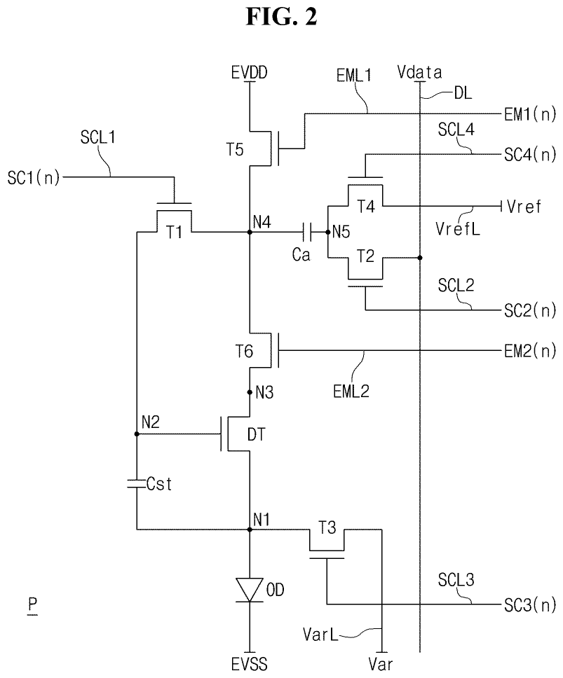

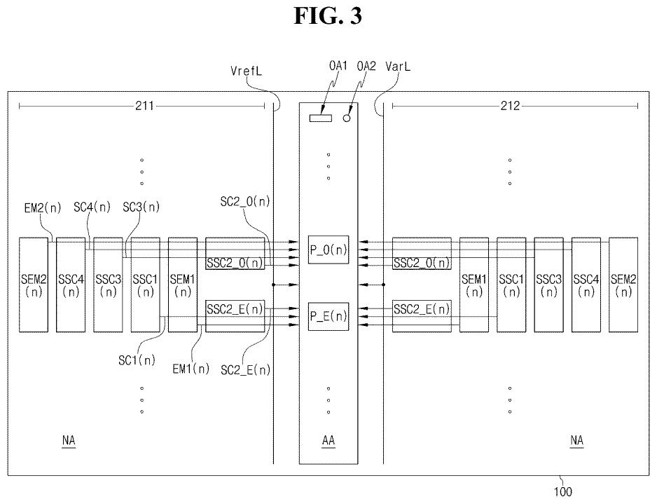

FIG. 1 is a view schematically illustrating a display apparatus according to a first embodiment of the present disclosure. FIG. 2 is a circuit view schematically illustrating an example of a pixel according to the first embodiment of the present disclosure. FIG. 3 is a view illustrating a configuration of a gate driving portion of the display apparatus according to the first embodiment of the present disclosure.

Prior to a specific description, a display apparatus 10 according to the present disclosure can include a light emitting display apparatus equipped with a light emitting diode. Furthermore, the display apparatus 10 of this embodiment can include all types of display apparatuses to which a VRR (variable refresh rate) method is applied.

For convenience of explanation, in the present disclosure, an organic light emitting display apparatus is described as an example of the display apparatus 10.

Referring to FIGS. 1 to 3, the display apparatus 10 of this embodiment can include a display panel 100 and a driving circuit portion that drives the display panel 100.

Here, the driving circuit portion can include, for example, a gate driving portion (or gate driving circuit) 210, a data driving portion (or data driving circuit) 220, and a timing control portion (or timing control circuit) 240. In addition, the driving circuit portion can include a power supply portion (or power supply circuit) 280 that supplies power required for driving the display panel 100, the gate driving portion 210, the data driving portion 220, and the timing control portion 240.

The display panel 100 can include a display region (or active area) AA that displays an image, and a non-display region (non-active area) NA arranged outside the display region AA (or surrounding the display region AA entirely or only in part(s)).

In the display region AA, a plurality of pixels P can be arranged in a matrix form along a plurality of horizontal lines (or row lines) and a plurality of vertical lines (or column lines).

The plurality of pixels P can include pixels that display different colors, for example, red, green, and blue pixels that display red, green, and blue, respectively, but not limited thereto.

In the display panel 100, various signal lines that transmit driving signals for driving the pixels P can be formed on a substrate.

In this regard, for example, a plurality of data lines DL that transmit data signals (or data voltages) which are image signals can extend in the vertical direction and be connected to the pixels P of the respective vertical lines.

In addition, a gate line GL that transmits a gate signal (or gate voltage) can extend in the horizontal direction and be connected to the pixel P of the corresponding horizontal line.

In this embodiment, a plurality of gate signals can be used to drive each pixel P, for example, a first scan signal SC1 to a fourth scan signal SC4, a first emission control signal EM1, and a second emission control signal EM2 can be used. Accordingly, a plurality of gate lines GL respectively transmitting the plurality of gate signals can be used, for example, a first scan line SCL1 to a fourth scan line SCL4, a first emission control line EML1, and a second emission control line EML2 can be used.

As such, the plurality of pixels P can be defined by the plurality of data lines DL and gate lines GL intersecting each other.

Each pixel P can include a light emitting diode OD as a light emitting element, and a plurality of transistors and at least one capacitor for driving the light emitting diode OD.

Meanwhile, in this embodiment, for convenience of explanation, an 7T2C structure in which the pixel P is equipped with seven transistors T1 to T6 and DT and two capacitors Cst and Ca as illustrated in FIG. 2 is taken as an example. Each pixel P in the display apparatus 10 of FIG. 1 can have the pixel configuration of FIG. 2.

Referring to FIG. 2, the pixel P can include a plurality of switching transistors, for example, first transistor T1 to sixth transistor T6, a driving transistor DT, a storage capacitor (or first capacitor) Cst, a pumping capacitor (or auxiliary capacitor or second capacitor) Ca, and the light emitting diode OD.

Each of the first to sixth transistors T1 to T6 and the driving transistor DT can include a first electrode, a second electrode, and a gate electrode. One of the first electrode and the second electrode can be a source electrode, and the other of the first electrode and the second electrode can be a drain electrode.

Each of the first to sixth transistors T1 to T6 and the driving transistor DT can be a N-type or P-type transistor. In this embodiment, an example is given in which the first to sixth transistors T1 to T6 and the driving transistor DT in the pixel P are all configured as N-type transistors, but not limited thereto.

The first transistor T1 to the sixth transistor T6 and the driving transistor DT can include semiconductors of the same material or can include semiconductors of different materials. In this regard, for example, some of the first transistor T1 to the sixth transistor T6 and the driving transistors DT can have one semiconductor layer among a polycrystalline silicon layer, an oxide semiconductor layer, and an amorphous silicon layer, and another some of the first transistor T1 to the sixth transistor T6 and the driving transistors DT can have another semiconductor layer among a polycrystalline silicon layer, an oxide semiconductor layer, and an amorphous silicon layer.

Since an oxide semiconductor has excellent off-current characteristics and has characteristics suitable for a switching transistor, at least one of the first transistor T1 to the sixth transistor T6 can have an oxide semiconductor layer. In addition, since a polycrystalline silicon has excellent mobility, the driving transistor DT can have a polycrystalline silicon layer. In another form, the first transistor T1 to the sixth transistor T6 and the driving transistor DT can be configured, for example, the driving transistor DT can have an oxide semiconductor layer.

In this embodiment, a case where the first to sixth transistors T1 and T6 include oxide semiconductor layers and the driving transistor DT includes an oxide semiconductor layer is taken as an example.

The gate signals provided to a n-th horizontal line of FIG. 2 (more specifically, at least one of an odd horizontal line and an even horizontal line constituting the n-th horizontal line) can be provided from a corresponding n-th stage of the gate driving portion 210. For example, four scan signals, first to fourth scan signals (SC1 to SC4: SC1(n) to SC4(n)) and two emission control signals, first and second emission control signals (EM1 and EM2: EM1(n) and EM2(n)) can be provided. In this case, in the display region AA, first to fourth scan lines SCL1 to SCL4 and first and second emission control lines EML1 and EML2 that are connected to the n-th stage and transmit the first to fourth scan signals SC1(n) to SC4(n) and the first and second emission control signals EM1(n) and EM2(n) to the pixel P can be arranged. Here, n can be a real number, such as a positive integer.

The first transistor T1 can function as a sampling transistor, the second transistor T2 can function as a data supply transistor, the third transistor T3 can function as a reset transistor, the fourth transistor T4 can function as a reference voltage supply transistor, and the fifth and sixth transistors T5 and T6 can function as emission control transistors.

The light emitting diode OD can include an anode electrode and a cathode electrode. The anode electrode of the light emitting diode OD can be connected to a first node N1, and the cathode electrode of the light emitting diode OD can be applied with a low-potential driving voltage EVSS.

The driving transistor DT can include, for example, a first electrode (or source electrode) connected to the first node N1, a second electrode (or drain electrode) connected to a third node N3, and a gate electrode connected to a second node N2. The driving transistor DT can provide a driving current to the light emitting diode OD based on a voltage of the first node N1 (i.e., the data voltage Vdata stored in the storage capacitor Cst).

The first transistor T1 can include, for example, a first electrode (or source electrode) connected to the second node N2, a second electrode (or drain electrode) connected to a fourth node N4, and a gate electrode receiving the first scan signal SC1(n).

The first transistor T1 can be turned on in response to the first scan signal SC1(n), and, during a data writing period, which is a horizontal period of the horizontal line on which the corresponding pixel P is arranged, the data voltage Vdata can be transmitted through the pumping capacitor Ca and applied (or written) to the gate electrode of the driving transistor DT.

Moreover, the first transistor T1 can be turned on in response to the first scan signal SC1(n), and a threshold voltage (Vth) of the driving transistor DT can be applied (or sampled) to the gate electrode of the driving transistor DT during a sampling period set prior to the data writing period of the horizontal line on which the corresponding pixel P is arranged.

The storage capacitor Cst can be connected, for example, between the first node N1 and the second node N2. In other words, the storage capacitor Cst can be connected between the first electrode and the gate electrode of the driving transistor DT. For example, first and second electrodes forming the storage capacitor Cst can be connected to the first and second nodes N1 and N2, respectively.

The storage capacitor Cst can store and maintain the data voltage Vdata and the threshold voltage (Vth) of the driving transistor DT.

The second transistor T2 can include, for example, a second electrode (or drain electrode) connected to the data line DL (or receiving the data voltage Vdata), a first electrode (or source electrode) connected to a fifth node N5, and a gate electrode receiving the second scan signal SC2(n). The second transistor T2 can be turned on in response to the second scan signal SC2(n), and can transmit the data voltage Vdata to the fifth node N5.

The third transistor T3 can include, for example, a second electrode (or drain electrode) connected to a reset voltage line VarL transmitting an anode reset voltage Var, a first electrode (or source electrode) connected to the first node N1, and a gate electrode receiving the third scan signal SC3(n).

The third transistor T3 can be turned on in response to the third scan signal SC3(n), and the anode reset voltage Var can be applied to the first node N1 (i.e., the anode electrode of the light emitting diode OD) during an initialization period set prior to the sampling period of the corresponding pixel P.

In addition, the third transistor T3 can be turned on in response to the third scan signal SC3(n), and the anode reset voltage Var together with the threshold voltage (Vth) can be applied (or sampled) to the gate electrode of the driving transistor DT during the sampling period of the corresponding pixel P.

The fourth transistor T4 can be, for example, connected to the second transistor T2 and at the fifth node N5, so that the fourth transistor T4 and the second transistor T2 can have a parallel connection relationship.

The fourth transistor T4 can include, for example, a second electrode (or drain electrode) connected to a reference voltage line VrefL that transmits a reference voltage Vref, a first electrode (or source electrode) connected to the fifth node N5, and a gate electrode that receives the fourth scan signal SC4(n).

The fourth transistor T4 can be turned on in response to the fourth scan signal SC4(n), and the reference voltage Vref can be applied to the fifth node N5 during the initialization period and the sampling period set prior to the data writing period of the corresponding pixel P.

The fifth transistor T5 can include, for example, a second electrode (or drain electrode) receiving a high-potential driving voltage EVDD, a first electrode (or source electrode) connected to the fourth node N4, and a gate electrode receiving the first emission control signal EM1(n).

The sixth transistor T6 can include a second electrode (or drain electrode) connected to the fourth node N4, a first electrode (or source electrode) connected to the third node N3 (or second electrode of the driving transistor DT), and a gate electrode receiving the second emission control signal EM2(n).

The fifth and sixth transistors T5 and T6 can be turned on in response to the corresponding first and second emission control signals EM1(n) and EM2(n), and a driving current can be supplied to the light emitting diode OD during an emission period set after the data writing period of the corresponding pixel P, and the light emitting diode OD can emit light with a luminance corresponding to the driving current.

In addition, the sixth transistor T6, which is directly connected to the driving transistor DT, can be turned on in response to the second emission control signal EM2(n), and can form a current path (or charge path) for sampling the threshold voltage (Vth) at the second node N2 together with the first transistor T1 during the sampling period of the corresponding pixel P.

In this regard, during the sampling period for sampling the threshold voltage (Vth) of the driving transistor DT, as previously mentioned, the first transistor T1, the third transistor T3, and the sixth transistor T6 can be turned on.

In this case, a current path can be formed along the third transistor T3, the driving transistor DT, the sixth transistor T6, and the first transistor T1. Accordingly, a voltage (Var+Vth), which reflects the anode reset voltage Var input through the third transistor T3 and the threshold voltage (Vth) of the driving transistor DT, can be applied to the second node N2 to which the gate electrode of the driving transistor DT is connected.

The pumping capacitor Ca can be connected, for example, between the fourth node N4 and the fifth node N5. In other words, the pumping capacitor Ca can be connected between the first electrodes, which are output electrode of the second and fourth transistors T2 and T4 connected in parallel, and the fourth node N4. For example, third and fourth electrodes forming the pumping capacitor Ca can be connected to the fourth and fifth nodes N4 and N5, respectively.

Through the pumping capacitor Ca, the data voltage Vdata input to the fifth node N5 during the data writing period can be reflected to the fourth node N4.

For example, after the reference voltage Vref is input to the fifth node N5, the data voltage Vdata can be input to the fifth node N5, and a difference between these voltage (ΔV=Vdata−Vref) can be reflected to the fourth node N4, which is in an electrically floating state, during the data writing period. As such, the voltage difference (ΔV) including the data voltage Vdata can be reflected to the second node N2 through the turned-on first transistor T1, so that the data voltage Vdata can be reflected to the gate electrode of the driving transistor DT.

As such, the pixel P of this embodiment can perform the sampling operation of the threshold voltage (Vth) of the driving transistor DT before the data writing operation.

As such, in this embodiment, the sampling operation for threshold voltage (Vth) compensation can be performed separately from the data writing operation. Accordingly, the sampling time of the threshold voltage (Vth) is not limited to the horizontal period when the data writing is performed, but can be set longer than the horizontal cycle.

By enabling the sampling operation for a long time, the threshold voltage (Vth) can be sufficiently sampled and reflected, reducing or preventing an error component in the sampled voltage.

Accordingly, the threshold voltage compensation of the pixel P can be improved, thus a compensation error can be reduced, and as a result, the image quality of the display apparatus 10 can be improved.

The driving method for implementing the threshold voltage compensation of this embodiment can be described in more detail below.

Referring to FIG. 1, the timing control portion 240 can process image data Do input from a host system to be suitable for size and resolution of the display panel 100 and supply them to the data driving portion 220. The timing control portion 240 can generate a gate control signal GCS and a data control signal DCS using synchronization signals input from the host system, for example, a dot clock signal CLK, a data enable signal DE, a horizontal synchronization signal HSY, and a vertical synchronization signal VSY. By supplying the gate control signal GCS and the data control signal DCS generated in this way to the gate driving portion 210 and the data driving portion 220, respectively, the gate driving portion 210 and the data driving portion 220 can be controlled.

The timing control portion 240 can be configured to be combined with various processors, for example, a microprocessor, a mobile processor, an application processor, etc., depending on a device to be mounted.

The host system can be, for example, a driving system that drives an electronic device to which the display apparatus 10 is applied. The electronic device can be, for example, one of a TV (Television), a navigation system, a monitor, a mobile device, and a wearable device.

The gate driving portion 210 can receive the gate control signal GCS from the timing control portion 240, generate the gate signals, and sequentially apply the gate signals to the gate lines GL. For example, the gate signals can be sequentially output from the top to the bottom in the vertical direction.

The gate driving portion 210 can be arranged, for example, on at least one side of the display region AA. In this embodiment, a case is taken as an example in which the gate driving portion 210 is configured to include first and second gate driving portions 211 and 212 arranged on both sides of the display region AA, for example, on the left and right sides of the display region AA.

The gate driving portion 210 can be formed directly in the non-display region NA on the substrate of the display panel 100, for example, in a GIP (gate-in panel) structure. In this case, the gate driving portion 210 can be formed during processes of forming elements of the display panel 100.

The gate driving portion 210 configured with the GIP structure can include, for example, a first scan driving circuit that sequentially outputs the first scan signals SC1, a second scan driving circuit that sequentially outputs the second scan signals SC2, a third scan driving circuit that sequentially outputs the third scan signals SC3, a fourth scan driving circuit that sequentially outputs the fourth scan signal SC4, a first emission driving circuit that sequentially outputs the first emission control signals EM1, and a second emission driving circuit that sequentially outputs the second emission control signals EM2.

Each of the first scan driving circuit to the fourth scan driving circuit and the first and second emission driving circuits can be configured with a shift register including a plurality of stages that output respective signals.

The gate driving portion 210 is described with further reference to FIG. 3. FIG. 3 illustrates a part of the gate driving portion 210, and for convenience of explanation, a configuration of a portion of the gate driving portion 210 that drives the n-th horizontal line configured with a n-th odd horizontal line (or 2n−1-th horizontal line) and a n-th even horizontal line (or 2n-th horizontal line) of the display region AA is illustrated.

In the first gate driving portion 211 of the gate driving portion 210, for example, first, third, and fourth scan stages SSC1(n), SSC3(n), and SSC4(n) that constitute the first, third, and fourth scan driving circuits, respectively, first and second emission stages SEM1(n) and SEM2(n) that constitute the first and second emission driving circuits, respectively, and odd and even second scan stages SSC2_O(n) and SSC2_E(n) that constitute the second scan driving circuit can be arranged.

In addition, in the second gate driving portion 212 of the gate driving portion 210, for example, the first, third, and fourth scan stages SSC1(n), SSC3(n), and SSC4(n) that constitute the first, third, and fourth scan driving circuits, respectively, the first and second emission stages SEM1(n) and SEM2(n) that constitute the first and second emission driving circuits, respectively, and the odd and even second scan stages SSC2_O(n) and SSC2_E(n) that constitute the second scan driving circuit can be arranged.

In the gate driving portion 210, the odd and even second scan stages SSC2_O(n) and SSC2_E(n) constituting the second scan driving circuit can be arranged so as to be

closest to the display region AA, and the second emission stage SEM2(n) can be arranged at the outermost part farthest from the display region AA. In addition, the first emission stage SEM1(n) can be arranged between the first to fourth scan stages SSC1(n) to SSC4(n).

The arrangement of the first to fourth scan stages SSC1(n) to SSC4(n) and the first and second emission stages SEM1(n) and SEM2(n) shown in FIG. 3 is an example, and they can be arranged in various combinations in the first and second gate driving portions 211 and 212.

The first scan stage SSC1(n) can generate the first scan signal SC1(n) and output it to the corresponding first scan line SCL1. Accordingly, the pixel P_O(n) of the n-th odd horizontal line and the pixel P_E(n) of the n-th even horizontal line can be commonly applied with the first scan signal SC1(n).

The odd second scan stage SSC2_O(n) can generate an odd second scan signal SC2_O(n) and output it to the corresponding odd second scan line SCL2, and the even second scan stage SSC2_E(n) can generate an even second scan signal SC2_E(n) and output it to the corresponding even second scan line SCL2. Accordingly, the pixel P_O(n) of the n-th odd horizontal line can be applied with the odd second scan signal SC2_O(n), and the pixel P_E(n) of the n-th even horizontal line can be applied with the even second scan signal SC2_E(n). Here, the odd second scan signal SC2_O(n) and the even second scan signal SC2_E(n) can have different timings. For example, the odd second scan signal SC2_O(n) and the even second scan signal SC2_E(n) can be applied to a horizontal period (or data writing period) of the n-th odd horizontal line and a horizontal period (or data writing period) of the n-th even horizontal line immediately following it, respectively.

The third scan stage SSC3(n) can generate the third scan signal SC3(n) and output it to the corresponding third scan line SCL3. Accordingly, the pixels P_O(n) and P_E(n) of the n-th odd and even horizontal lines can be commonly applied with the third scan signal SC3(n).

The fourth scan stage SSC4(n) can generate the fourth scan signal SC4(n) and output it to the corresponding fourth scan line SCL4. Accordingly, the pixels P_O(n) and P_E(n) of the n-th odd and even horizontal lines can be commonly applied with the fourth scan signal SC4(n).

The first emission stage SEM1(n) can generate the first emission control signal EM1(n) and output it to the corresponding first emission control line EML1. Accordingly, the pixels P_O(n) and P_E(n) of the n-th odd and even horizontal lines can be commonly applied with the first emission control signal EM1(n).

The second emission stage SEM2(n) can generate the second emission control signal EM2(n) and output it to the corresponding second emission control line EML2. Accordingly, the pixels P_O(n) and P_E(n) of the n-th odd and even horizontal lines can be commonly applied with the second emission control signal EM2(n).

Referring to FIG. 3, the reference voltage line VrefL and the reset voltage line VarL can be arranged between the gate driving portion 210 and the display region AA.

The reference voltage line VrefL and the reset voltage line VarL can respectively supply the reference voltage Vref and the anode reset voltage Var from the power supply portion 280 to the pixels P within the display region AA.

In FIG. 3, each of the reference voltage line VrefL and the reset voltage line VarL is illustrated as being located only on the left or right side of the display region AA, but not limited thereto, and each of the bias voltage line VobsL, the reset voltage line VarL, and the initialization voltage line ViniL can be located on both sides, and even if located on one side, the location on the left or right side is not limited.

Furthermore, referring to FIG. 3, one or more optical regions OA1 and OA2 can be disposed in the display region AA.

The one or more optical regions OA1 and OA2 can be arranged to overlap one or more optical electronic devices, for example, a photographing device such as a camera (or image sensor), and/or a detection sensor such as a proximity sensor and an illuminance sensor. For the operation of the optical electronic device, the one or more optical regions OA1 and OA2 can have a light-transmitting structure formed therein and can have transmittance of a certain level or higher. In other words, a number of pixels P per unit area in the one or more optical regions OA1 and OA2 can be smaller than a number of pixels P per unit area in a regular region excluding the optical regions OA1 and OA2 in the display region AA. For example, a resolution of the one or more optical regions OA1 and OA2 can be lower than a resolution of the regular region within the display region AA.

Referring back to FIG. 1, the data driving portion 220 can receive the image data Do and the data control signal DCS from the timing control portion 240, and in response to the data control signal DCS, the data driving portion 220 can convert the image data Do into analog image data i.e., data voltages Vdata, and outputs them to the respective data lines DL.

The power supply portion 280 can generate DC power required for driving the pixel array and the driving circuit portion of the display panel 100 using, for example, a DC-DC converter. The DC-DC converter can include a charge pump, a regulator, a buck converter, a boost converter, etc.

The power supply portion 280 can receive, for example, a power voltage Vcc that is a driving voltage for driving the display apparatus (10) from the host system, and generate the DC voltages such as the gate low voltages VGL and VEL, the gate high voltages VGH and VEH, the high-potential driving voltage EVDD, and the low-potential driving voltage EVSS. The gate low voltages VGL and VEL and the gate high voltages VGH and VEH can be supplied to the gate driving portion 210. The high-potential driving voltage EVDD and the low-potential driving voltage EVSS can be supplied in common to the pixels P in the display panel 100.

The display apparatus 10 of this embodiment configured as above can be driven at low power in the VRR method in which a refresh cycle (or refresh rate) is adjusted, in order to reduce power consumption.

In this regard, in a normal driving mode which is a high-speed driving mode, the display apparatus 10 can operate to refresh (or update) an image of the display panel 100 (or the data voltage Vdata applied to each pixel P) by frame. For example, in the high-speed driving mode, the display apparatus 10 can be driven at a refresh rate of 120 Hz, so that a refresh operation can be performed for each of 120 frames per second. In this way, in the high-speed driving mode, all frames can be assigned as refresh frames in which the data voltage Vdata is written.

In the case of displaying a still image, etc., the display apparatus 10 can be driven in a low-speed driving mode. In the low-speed driving mode, the refresh rate is reduced, so that the refresh cycle of the display panel 100 becomes longer. For example, in the case of low-speed driving with a refresh rate of 10 Hz, one refresh frame and 11 consecutive skip frames can be alternately repeated. As such, in the low-speed driving mode, the frames can be divided into the refresh frame in which the data voltage Vdata is written and the skip frame in which the data voltage Vdata is not written and the writing is skipped.

As such, in the low-speed driving mode, as the driving frequency decreases, the cycle of the refresh frame (or the interval between the refresh frames) becomes longer, and one or more skip frames exist between the refresh frames.

During the skip frame, the image refresh operation is stopped, so that power consumption can be reduced.

In the refresh frame when the data voltage Vdata is written, the first scan signal SC1 to the fourth scan signal SC4 (more specifically, their scan pulses) can be applied in order to write the data voltage Vdata to the corresponding pixel P.

In addition, in the skip frames when the data voltage Vdata is not written and maintained, an operation of applying the anode reset voltage Var to reset the anode electrode of the light emitting diode OD can be performed. To this end, the third scan signal SC3 (more specifically, its scan pulse) for providing the anode reset voltage Var to the pixel P can be applied.

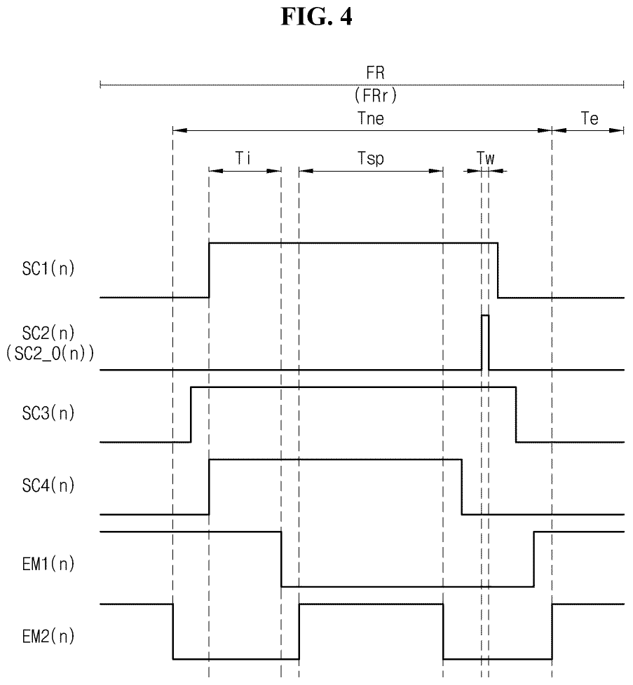

Hereinafter, the driving in the refresh frame in which the data voltage Vdata is written and the threshold voltage (Vth) of the driving transistor (DT) is sampled and compensated is described with further reference to FIGS. 4 to 8.

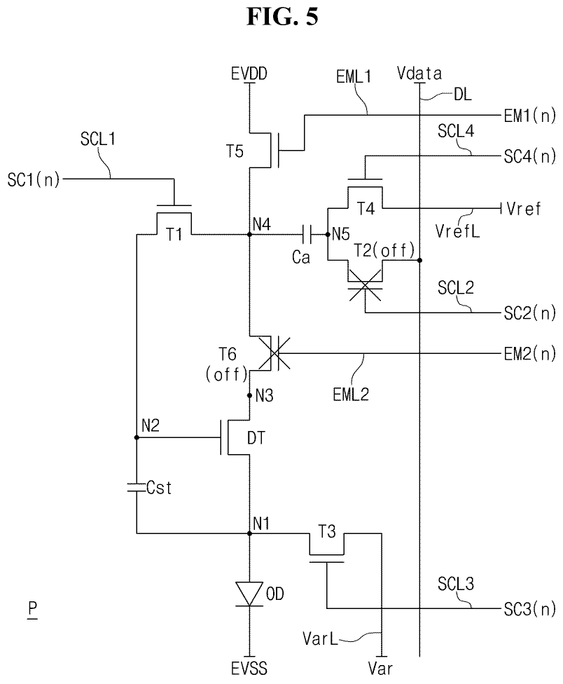

FIG. 4 is a timing chart schematically illustrating an example of driving signals for driving a pixel (e.g., the pixel P in FIG. 1) according to the first embodiment of the present disclosure. FIGS. 5 to 8 are views illustrating operating states of elements within a pixel (e.g., the pixel P in FIG. 1) in an initialization period, a sampling period, a data writing period, and an emission period, respectively, in driving using the driving signals of FIG. 4.

In FIGS. 4 to 8, for convenience of explanation, the refresh driving of the pixel P_O(n) of an odd horizontal line among the pixels (P) of the n-th horizontal line is illustrated as an example. To the pixel P_E(n) of the n-th even horizontal line, the corresponding second scan signal SC2_E(n) can be applied during the corresponding horizontal period.

First, referring to FIG. 4, the driving in a refresh frame FRr, which is a frame FR in which the refresh operation is performed, is described. The refresh frame FRr can be divided into a non-emission period Tne and an emission period Te.

The non-emission period Tne and the emission period Te can be defined by the first and second emission control signals EM1(n) and EM2(n) of the refresh frame FRr. In this

regard, a turn-on level section e.g., a high-level section of both the first and second emission control signals EM1(n) and EM2(n) can correspond to the emission period Te, and a turn-off level section e.g., a low-level section of at least one of the first and second emission control signals EM1(n) and EM2(n) can correspond to the non-emission period Tne. The non-emission period Tne can be substantially a period in which the scan signals SC1(n) to SC4(n) are applied and a data refresh operation is performed, and can be said to correspond to a data refresh period or a scan driving period.

Within the non-emission period Tne of the refresh frame FRr, for example, an initialization period Ti, a sampling period Tsp, and a data writing period Tw can be sequentially performed.

Regarding the initialization period Ti, referring to FIGS. 4 and 5, for example, the first scan signal SC1(n) can have a high level, which is a turn-on level, the third scan signal SC3(n) can have a high level, which is a turn-on level, the fourth scan signal SC4(n) can have a high level, which is a turn-on level, and the first emission control signal EM1(n) can have a high level which is a turn-on level.

In addition, during the initialization period Ti, the second scan signal (SC2(n)) can have a low level, which is a turn-off level, and the second emission control signal (EM2(n)) can have a low level, which is a turn-off level.

In response to the scan signals SC1(n) to SC4(n) and the emission control signals EM1(n) and EM2(n), the first transistor T1, the third transistor T3, the fourth transistor T4, and the fifth transistor T5 can be turned on, and the second transistor T2 and the sixth transistor T6 can be turned off.

Accordingly, the anode reset voltage Var can be provided to the first node N1 by the third transistor T3 in the turned-on state, so that the initialization, i.e., anode reset, of the anode electrode of the light emitting diode OD can be performed.

In addition, the high-potential driving voltage EVDD can be provided to the second and fourth nodes N2 and N4 by the first and fifth transistors T1 and T5 in the turned-on state, and the reference voltage Vref can be provided to the fifth node N5 through the fourth transistor T4 in the turned-on state. As a result, the voltage of the gate electrode of the driving transistor DT can be initialized, and the voltage stored in the storage capacitor Cst and the voltage stored in the pumping capacitor Ca can be initialized.

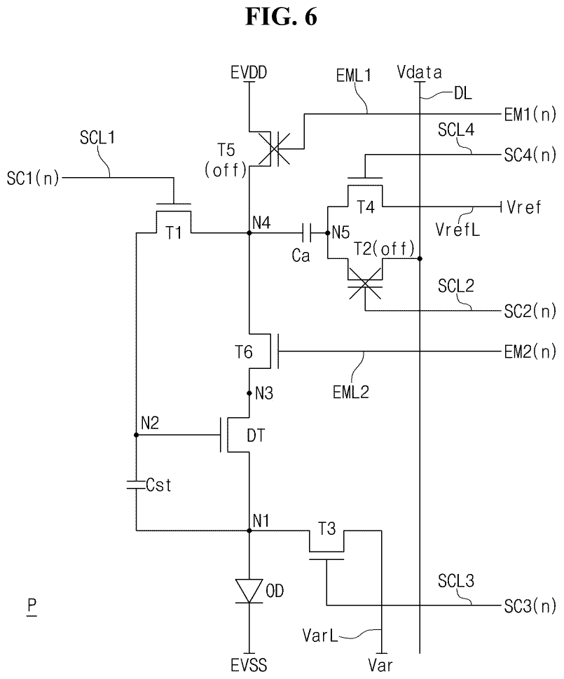

Next, regarding the sampling period Tsp performed after the initialization period Ti, referring to FIGS. 4 and 6, for example, the first scan signal SC1(n) can have a high level, which is a turn-on level, the third scan signal SC3(n) can have a high level, which is a turn-on level, the fourth scan signal SC4(n) can have a high level, which is a turn-on level, and the second emission control signal EM2(n) can have a high level (or high pulse) which is a turn-on level.

In addition, during the sampling period Tsp, the second scan signal SC2(n) can have a low level, which is a turn-off level, and the first emission control signal EM1(n) can have a low level which is a turn-off level.

In response to the scan signals SC1(n) to SC4(n) and the emission control signals EM1(n) and EM2(n), the first transistor T1, the third transistor T3, the fourth transistor T4, and the sixth transistor T6 can be turned on, and the second transistor T2 and the fifth transistor T5 can be turned off.

Thus, the third node N3 to which the second electrode of the driving transistor DT is connected, and the second node N2 to which the gate electrode of the driving transistor DT can be connected can be electrically short-circuited by the first and sixth transistors T1 and T6 in the turned-on state. Thus, the driving transistor DT can be in a diode-connection state in which the gate electrode and the drain electrode of the driving transistor are electrically short-circuited.

At this time, the third transistor T3 can be turned on, so that a current path can be formed along the third transistor T3, the driving transistor DT, the sixth transistor T6, and the first transistor T1.

Accordingly, a voltage (Var+Vth), which reflects the anode reset voltage Var input through the third transistor T3 and the threshold voltage (Vth) of the driving transistor DT, can be applied to the second node N2 i.e., the gate electrode of the driving transistor DT.

The anode reset voltage Var and the threshold voltage (Vth) applied to the second node N2 can be charged and stored in the storage capacitor Cst (e.g., the second electrode of the storage capacitor Cst connected to the second node N2).

The high-pulse section of the second emission control signal EM2(n), as the sampling period Tsp during which the threshold voltage (Vth) is reflected to the second node N2, which substantially defines the sampling period Tsp, can be set longer than the data writing period Tw set as the horizontal period, and preferably, can be set to be equal to or more than twice the horizontal period.

When the sampling period Tsp can be set to a considerably long time, separated from the data writing period Tw, the threshold voltage (Vth) of the driving transistor DT can be sufficiently sampled during the sampling operation.

Accordingly, an error component of the threshold voltage (Vth) that can occur when sampling for a short time, such as a horizontal period, can be reduced or prevented, so that the error of the threshold voltage compensation can be reduced, thereby enhancing a threshold voltage compensation, and consequently, the image quality of the display apparatus 10 can be improved.

Meanwhile, even during the sampling period Tsp, the anode reset voltage Var can be continuously provided to the first node N1 by the third transistor T3 in the turned-on state, so that the initialization i.e., the anode reset of the anode electrode of the light emitting diode OD can be performed.

In addition, the reference voltage Vref can be continuously provided to the fifth node N5 by the fourth transistor T4 in the turned-on state, so that the fifth node N5 can maintain the voltage in the initialization period.

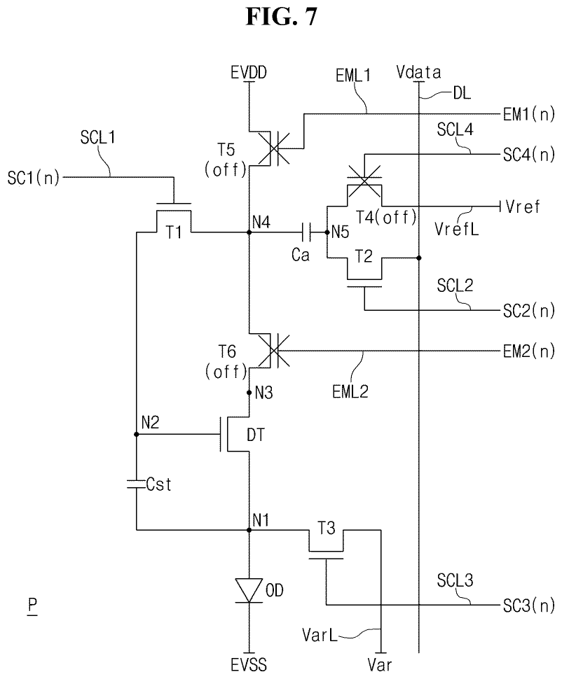

Next, regarding the data writing period Tw performed after the sampling section Tsp, referring to FIGS. 4 and 7, for example, the first scan signal SC1(n) can have a high level, which is a turn-on level, the second scan signal SC2(n) can have a high level, which is a turn-on level, and the third scan signal SC3(n) can have a high level which is a turn-on level.

In addition, during the data writing period Tw, the fourth scan signal SC4(n) can have a low level, which is a turn-off level, the first emission control signal EM1(n) can have a low level, which is a turn-off level, and the second emission control signal EM2(n) can have a low level which is a turn-off level.

In response to the scan signals SC1(n) to SC4(n) and the emission control signals EM1(n) and EM2(n), the first transistor T1, the second transistor T2, and the third transistor T3 can be turned on, and the fourth transistor T4, the fifth transistor T5, and the sixth transistor T6 can be turned off.

Accordingly, the data voltage Vdata can be provided to the fifth node N5 by the second transistor T2 in the turned-on state, and the data voltage Vdata can be reflected to the fourth node N4 through the pumping capacitor Ca.

In this regard, the voltage of the fifth node N5 can change from the reference voltage Vref input in the sampling period Tsp to the data voltage Vdata input in the data writing period Tw.

In this case, a voltage difference (ΔV), (Vdata−Vref), resulting from the voltage change of the fifth node N5, can be reflected to the fourth node N4 in an electrically floating state in the data writing period Tw by a voltage maintenance action (or voltage pumping action) of the pumping capacitor Ca connected between the fourth and fifth nodes N4 and N5. As such, the pumping capacitor Ca can perform a voltage pumping function that reflects the voltage change of the fifth node N5 in the data writing period Tw to the fourth node N4.

The voltage difference (ΔV) reflecting the data voltage Vdata can be transmitted to the second node N2 through the first transistor T1 turned on in the data writing period Tw, so that it can be reflected in the voltage of the second node N2 i.e., the voltage of the gate electrode of the driving transistor DT.

For example, in the data writing period Tw, the voltage difference (ΔV=(Vdata−Vref)) can be reflected in the second node N2, so that the voltage of the second node N2 can be changed to reflect the data voltage Vdata, and this voltage of the second node N2 can be charged and stored in the storage capacitor Cst (e.g., the second electrode of the storage capacitor Cst connected to the second node N2).

Even in the data writing period Tw, the anode reset voltage Var can be continuously provided to the first node N1 by the third transistor T3 in the turned-on state, so that the initialization i.e., the anode reset of the anode electrode of the light emitting diode OD can be performed.

Regarding the data writing operation of the n-th odd and even horizontal lines, immediately after the data writing period Tw for the pixel P_O(n) of the n-th odd horizontal line is performed during the corresponding horizontal period, the data writing period Tw for the pixel P_E(n) of the n-th even horizontal line can be performed during the corresponding horizontal period.

As described above, after the data writing period Tw is completed, a driving current can be supplied to the light emitting diode OD during the emission period Te to perform the light-emission operation.

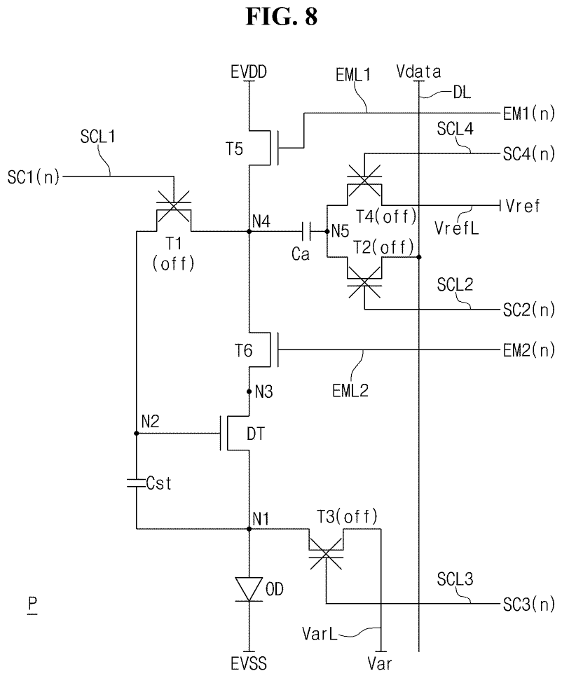

Regarding the emission period Te, referring to FIGS. 4 and 8, for example, the first scan signal SC1(n) to the fourth scan signal SC4(n) can all have a low level, which is a turn-off level, and the first and second emission control signals EM1(n) and EM2(n) can all have a high level which is a turn-on level.

In response to the scan signals SC1(n) to SC4(n) and the emission control signals EM1(n) and EM2(n), the first transistor T1 to the fourth transistor T4 can all be turned off, and the fifth and sixth transistors T5 and T6 can all be turned on.

Accordingly, through the turned-on fifth and sixth transistors T5 and T6, a current path can be formed from a terminal of the high-potential driving voltage EVDD to a terminal of the low-potential driving voltage EVSS. At this time, the driving transistor DT can be turned on according to the voltage of the second node N2 i.e., the gate electrode of the driving transistor DT to which the data voltage Vdata is reflected, so that the driving current corresponding to the data voltage Vdata can be provided to the light emitting diode OD, and the light emitting diode OD can emit light.

Here, as mentioned above, before the data writing period Tw, the sampling period Tsp can be set to a time longer than the horizontal period, so that the threshold voltage (Vth) can be sufficiently sampled and reflected into the voltage of the gate electrode of the driving transistor DT, so that the error component of the threshold voltage (Vth) can be reduced or prevented.

Accordingly, the influence of the error component of the threshold voltage (Vth) on the driving current generated in the emission period Te can be reduced or eliminated, so

that the driving current with improved compensation for the threshold voltage can be provided to the light emitting diode OD.

As such, by improving the threshold voltage compensation, emission characteristics of the light emitting diode OD can be improved, and the image quality characteristics of the display apparatus 10 can be enhanced.

In the above-described embodiment, an example is given where the four different scan signals SC1 to SC4 and the two different emission control signals EM1 and EM2 are used to drive the pixels P of each horizontal line.

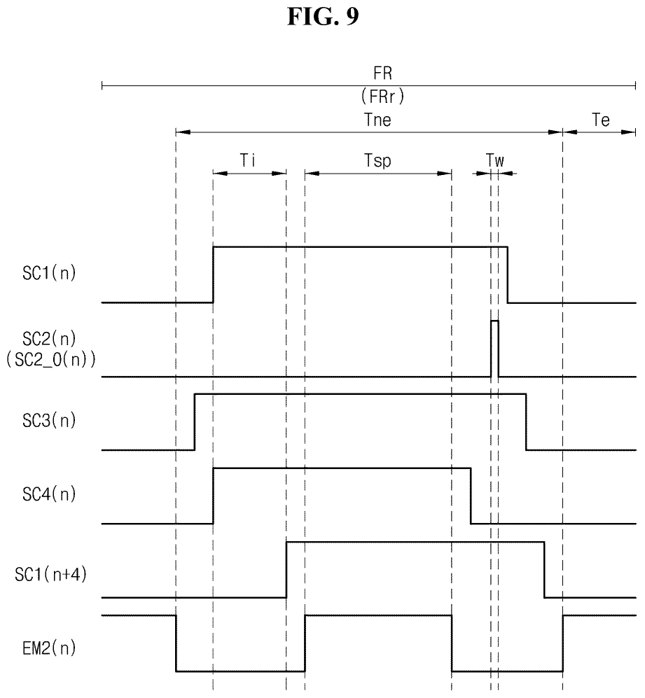

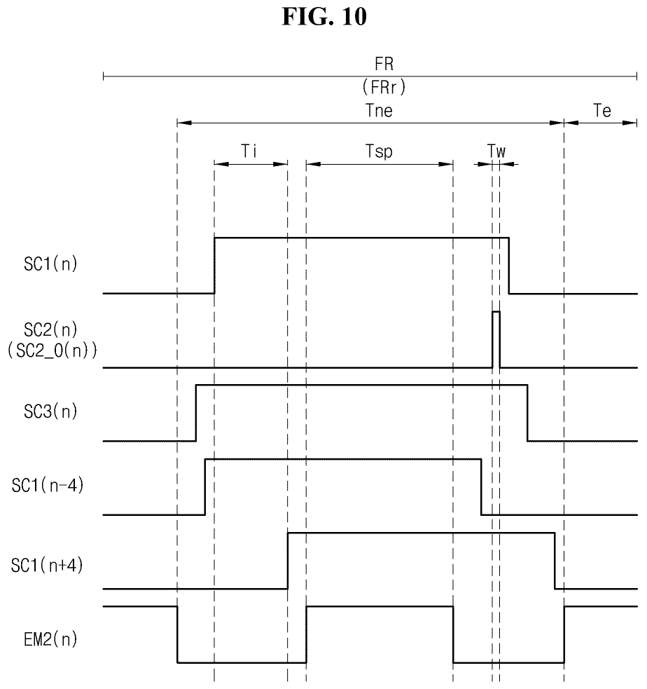

As another example, at least one of the scan signals SC1 to SC4 or at least one of the emission control signals EM1 and EM2 can be omitted. This can refer to FIGS. 9 and 10.

FIG. 9 is a timing chart schematically illustrating driving signals for driving a pixel of a display apparatus according to a first modified example of the first embodiment of the present disclosure, and FIG. 10 is a timing diagram schematically illustrating driving signals for driving a pixel of a display apparatus according to a second modified example of the first embodiment of the present disclosure.

The pixels P to which the driving signals of the first and second modified examples of FIGS. 9 and 10 are applied can be configured identically to the pixel P illustrated in FIG. 2, and in this case, the fifth transistor T5 can be configured as a P-type transistor.

First, regarding the first modified example, referring to FIG. 9, the first emission control signal EM1(n) provided to the n-th horizontal line in the aforementioned embodiment (see FIG. 4) can be omitted, and instead, the first scan signal SC1 provided to the subsequent horizontal line, for example, the first scan signal SC1(n+4) provided to the n+4-th horizontal line, can be used. In other words, the P-type fifth transistor T5 can be applied with the first scan signal SC1(n+4) of the n+4-th horizontal line, replacing the first emission control signal EM1(n).

Next, regarding the second modified example, referring to FIG. 10, similarly to the first modified example of FIG. 9, the P-type fifth transistor T5 can be applied with the first scan signal SC1(n+4) of the n+4-th horizontal line, replacing the first emission control signal EM1(n). In addition, in the second modified example, for the fourth transistor T4, the fourth scan signal SC4(n) provided to the n-th horizontal line in the aforementioned embodiment (see FIG. 4) can be omitted, and instead, the first scan signal SC1(n−4) of the n−4-th horizontal line can be applied to the fourth transistor T4.

As such, according to the first modified example, the first emission control signal EM1 can be omitted, and according to the second modified example, the first emission control signal EM1 and the fourth scan signal SC4 can be omitted. Accordingly, in the gate driving portion 210, the first emission stages SEM1 that generate the first emission control signals EM1 can be omitted, or in addition, the fourth scan stages SSC4 that generate the fourth scan signals SC4 can be omitted, and accordingly, a narrow bezel can be implemented.

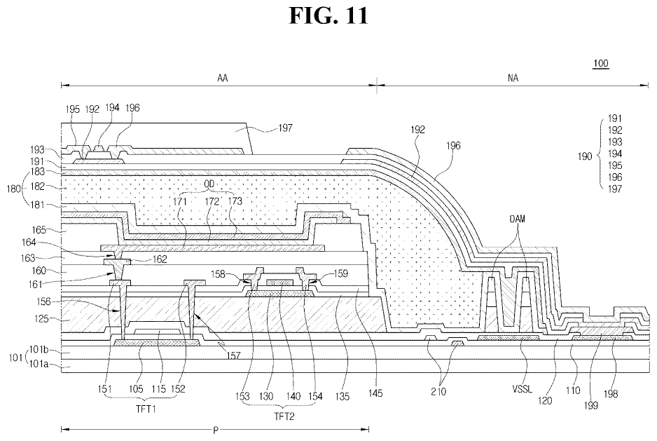

Hereinafter, an example of a cross-sectional structure of the display panel 100 of this embodiment is described with further reference to FIG. 11. FIG. 11 is a cross-sectional view schematically illustrating an example of a cross-sectional structure of a display panel according to the first embodiment of the present disclosure.

In FIG. 11, for convenience of explanation, two thin film transistors TFT1 and TFT2 are illustrated in the pixel P within the display region AA. Here, the thin film transistor TFT1 positioned relatively lower and closer to the substrate 101 is referred to as a first thin film transistor TFT1, which can be a polycrystalline silicon thin film transistor. The thin film transistor TFT2 positioned relatively upper and farther from the substrate 101 is referred to as a second thin film transistor TFT2, which can be an oxide thin film transistor.

The first thin film transistor TFT1 can be a driving transistor (DT of FIG. 2), but not limited thereto. In addition, the second thin film transistor TFT2 can be one of the first to sixth transistors (T1 to T6 of FIG. 2) that are switching thin film transistors, for example, the first transistor (T1 of FIG. 2) connected to the storage capacitor (Cst of FIG. 2), but not limited thereto.

The substrate 101 can be configured a, for example, a thin glass substrate (or glass film) or a plastic substrate (or plastic film) so as to implement a flexible characteristics of the display panel 100.

Here, in a case where the substrate 101 is configured as a glass substrate, for example, the substrate 101 can have a thickness of approximately 0.2 mm.

In a case where the substrate 101 is configured as a plastic substrate, for example, the substrate 101 can include at least one polyimide layer. In this embodiment, the substrate 101 configured of two polyimide layers, which are a first polyimide layer 101a and a second polyimide layer 101b, is taken as an example.

The first thin film transistor TFT1 can include a first semiconductor layer 105 disposed on the substrate 101, a first gate electrode 115 overlapping the semiconductor layer 105 with a first insulating layer 110 interposed therebetween, and a first source electrode 151 and a first drain electrode 152 located on a fourth insulating layer 145 over the first gate electrode 115. Here, the first semiconductor layer 105 can be formed of polycrystalline silicon, but not limited thereto.

The first semiconductor layer 105 can include a central channel region and source and drain regions on both sides thereof. The first source electrode 151 and the first drain electrode 152 can be connected to the source region and the drain region of the first semiconductor layer 105 through the first and second contact holes 156 and 157 that are formed in the insulating layers 110, 120, 125, 135, and 145 located below the first source electrode 151 and the first drain electrode 152.

A second insulating layer 120 can be formed on the first gate electrode 115 of the first thin film transistor TFT1.

A first interlayered insulating layer 125 can be formed on the second insulating layer 120. The second thin film transistor TFT2 can be formed on the first interlayered insulating layer 125.

The second thin film transistor TFT2 can include a second semiconductor layer 130 on the first interlayered insulating layer 125, a second gate electrode 140 overlapping the second semiconductor layer 130 with a third insulating layer 135 interposed therebetween, and a second source electrode 153 and a second drain electrode 154 located on the fourth insulating layer 145 over the second gate electrode 140. Here, the second semiconductor layer 130 can be formed of an oxide semiconductor, but not limited thereto.

The second semiconductor layer 130 can include a central channel region and source and drain regions on both sides thereof. The second source electrode 153 and the second drain electrode 154 can be connected to the source and drain regions of the second semiconductor layer 130 through third and fourth contact holes 158 and 159 formed in the insulating layers 135 and 145 located below the second source electrode 153 and the second drain electrode 154.

A second interlayered insulating layer (or first planarization layer) 160 can be formed on the second thin film transistor TFT2.

Here, the first, second, third, and fourth insulating layers 110, 120, 135, and 145 can be formed of an inorganic insulating material such as silicon nitride or silicon oxide, but not limited thereto.

In addition, the first and second interlayered insulating layers 125 and 160 can be formed of an organic insulating material such as photo acrylic or benzocyclobutene, but not limited thereto.

A connection electrode 162 can be formed on the second interlayered insulating layer 160. The connection electrode 162 can be connected to the first source electrode 151 through a contact hole 161 formed in the second interlayered insulating layer 160.

A third interlayered insulating layer (or second planarization layer) 163 can be formed on the connection electrode 162. The third interlayered insulating layer 163 can be formed of an organic insulating material such as photo acrylic or benzocyclobutene, but not limited thereto.

The light emitting diode OD and a bank 165 can be formed on the third interlayered insulating layer 163.

The light emitting diode OD can include an anode electrode (or first electrode) 171, a light emitting layer 172, and a cathode electrode (or second electrode) 173.

The anode electrode 171 can be connected to the connection electrode 162 through the contact hole 164 formed in the third interlayered insulating layer 163.

The bank 165 can be disposed along a boundary of the pixel P and can be formed to cover an edge of the anode electrode 171. The light emitting layer 172 can be formed on the anode electrode 171 exposed through an opening of the bank 165.

The cathode electrode 173 can be formed on the light emitting layer 172 and can be applied with the low-potential driving voltage (EVSS of FIG. 2).

An encapsulation layer 180 can be formed on the cathode electrode 173. The encapsulation layer 180 can include at least one inorganic encapsulation layer and at least one organic encapsulation layer, but not limited thereto. In this disclosure, a structure of the encapsulation layer 180, in which a first encapsulation layer 181, a second encapsulation layer 182, and a third encapsulation layer 183 are sequentially stacked, is described as an example.

The first encapsulation layer 181 can be formed on the substrate 101 on which the cathode electrode 173 is formed. The third encapsulation layer 183 can be formed on the substrate 101 on which the second encapsulation layer 182 is formed, and can be formed to surround an upper surface, a lower surface, and a side surface of the second encapsulation layer 182 together with the first encapsulation layer 181. The first encapsulation layer 181 and the third encapsulation layer 183 can minimize or prevent external moisture or oxygen from penetrating into the light emitting diode OD. The first encapsulation layer 181 and the third encapsulation layer 183 can be formed of an inorganic insulating material capable of low-temperature deposition, such as silicon nitride, silicon oxide, silicon oxynitride, or aluminum oxide.

The second encapsulation layer 182 can acts as a buffer to relieve stress between layers due to bending of the display apparatus 10, and can flatten steps between layers. The second encapsulation layer 182 can be formed on the substrate 101 on which the first encapsulation layer 181 is formed, using a non-photosensitive organic insulating material such as acrylic resin, epoxy resin, phenolic resin, polyamide resin, polyimide resin, polyethylene, or silicon oxycarbon (SiOC), or a photosensitive organic insulating material such as photo acrylic, but not limited thereto. When the second encapsulation layer 182 is formed through an inkjet method, a dam DAM can be placed in the non-display region NA to reduce or prevent the second encapsulation layer 182 in liquid form from spreading to an edge of the substrate 101. The dam DAM can be disposed closer to the edge of the substrate 101 than the second encapsulation layer 182. By the dam DAM, the second encapsulation layer 182 can be reduced or prevented from spreading to a pad region, where a conductive pad is disposed, on an outermost edge of the substrate 101.

The dam DAM can be designed to reduce or prevent the spreading of the second encapsulation layer 182, but if the second encapsulation layer 182 is formed to exceed a height of the dam DAM during a process, the second encapsulation layer 182 as an organic layer can be exposed to an outside, so that moisture, etc. can easily penetrate into the light emitting element. To prevent this, 10 or more dam DAM can be formed in succession, but not limited thereto.

The dam DAM can be formed simultaneously with the first interlayered insulating layer 125, the second interlayered insulating layer 160, and the third interlayered insulating layer 163. When forming the first interlayered insulating layer 125, a lower layer of the dam DAM can be formed together, and when forming the second and third interlayered insulating layers 160 and 163, an upper layer of the dam DAM can be formed together, so that the dam DAM can be formed in a triple laminated structure. As another example, the dam DAM can be formed with one or two of the first, second, and third interlayered insulating layers 125, 160, and 163.

Accordingly, the dam DAM can be formed of the same material as the first interlayered insulating layer 125, the second interlayered insulating layer 160, and the third interlayered insulating layer 163, but not limited thereto.

The dam DAM can be formed to overlap a low-potential driving voltage line VSSL. For example, the low-potential driving voltage line VSSL can be formed at a lower layer of a region, where the dam DAM is located, in the non-display region NA.

The low-potential driving voltage line VSSL and the gate driving portion 210 configured in the GIP structure can be formed along a periphery of the display panel 100, and the low-potential driving voltage line VSSL can be located outside the gate driving portion 210. In addition, the low-potential driving voltage line VSSL can be connected to the cathode electrode 173 to apply the low-potential driving voltage EVSS. The gate driving portion 210 is simply shown in a planar and cross-sectional manner in the drawings, but can be configured with the same structure as the first thin film transistor TFT1 and/or the second thin film transistor TFT2 of the display region AA.

A touch layer (or touch element layer) 190 can be disposed on the encapsulation layer 180. In the touch layer 190, a touch buffer layer 191 can be positioned between a touch sensor metal including touch electrode connection lines 192 and 194 and touch electrodes 195 and 196, and the cathode electrode 173 of the light emitting diode OD.

The touch buffer layer 191 can block a chemical solution (developer, etchant, etc.) used in a manufacturing process of the touch sensor metal disposed on the touch buffer layer 191 or moisture from the outside from penetrating into the light emitting layer 172 containing an organic material. Accordingly, the touch buffer layer 191 can reduce or prevent damage to the light emitting layer 172 that is vulnerable to the chemical solution or moisture.

According to a mutual-capacitance-based touch sensor structure, the touch electrodes 195 and 196 can be disposed on the touch buffer layer 191, and the touch electrodes 195 and 196 can be arranged to cross each other.

The touch electrode connection lines 192 and 194 can electrically connect the touch electrodes 195 and 196. One of the touch electrode connection lines 192 and 194, and the touch electrodes 195 and 196 can be located at different layers with a touch insulation layer 193 interposed therebetween. In addition, one of the touch electrode connection lines 192 and 194 and the other of the touch electrode connection lines 192 and 194 can be located at different layers with the touch insulation layer 193 interposed therebetween.

The touch electrode connection lines 192 and 194 can be arranged to overlap the bank 165, thereby reducing or preventing decrease in aperture ratio, but not limited thereto.

Meanwhile, a part of the touch electrodes 195 and 196 and a part of the touch electrode connection line 192 can extend along the top and side surfaces of the encapsulation layer 180 and the top and side surfaces of the dam DAM and be electrically connected to a touch driving circuit through a touch pad 198 and 199.

A part of the touch electrodes 195 and 196 and a part of the touch electrode connection line 192 can receive a touch driving signal from the touch driving circuit and transmit it to the touch electrodes 195 and 196, and can transmit a touch sensing signal detected by the touch electrodes 195 and 196 to the touch driving circuit.

In this regard, for example, a driving IC (e.g., data IC, etc.) of the data driving portion 220 including the touch driving circuit can be configured in a COF type and connected to the non-display region NA of the substrate 101 of the display panel 100, and in this case, an end of the touch pad 198 and 199 can be connected to a flexible circuit film on which the driving IC is mounted, so that a signal can be transmitted.

A touch protective layer 197 can be disposed on the touch electrodes 195 and 196. In the drawing, the touch protective layer 197 is shown as being disposed only on the touch electrodes 195 and 196, but not limited thereto, and the touch protective layer 197 can extend before or after the dam DAM to be disposed on the touch electrode connection line 192.

In addition, a color filter can be disposed on the encapsulation layer 180. The color filter can be positioned on the touch layer 190, or between the encapsulation layer 180 and the touch layer 190.

### Second Embodiment

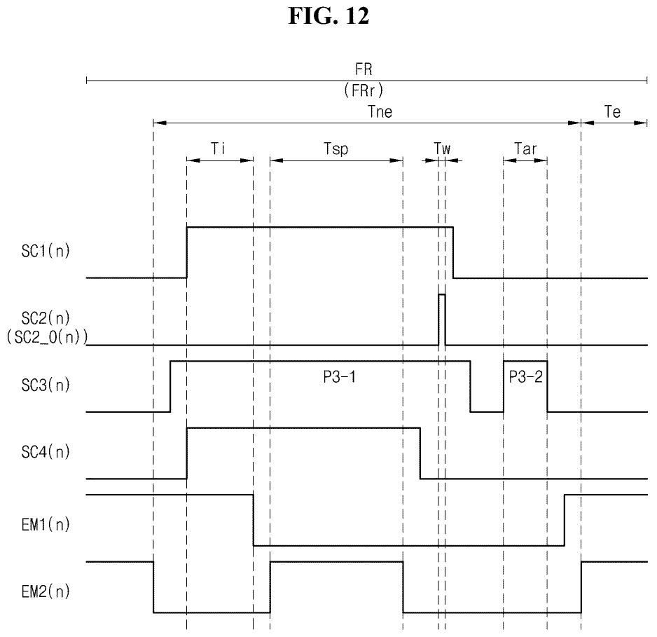

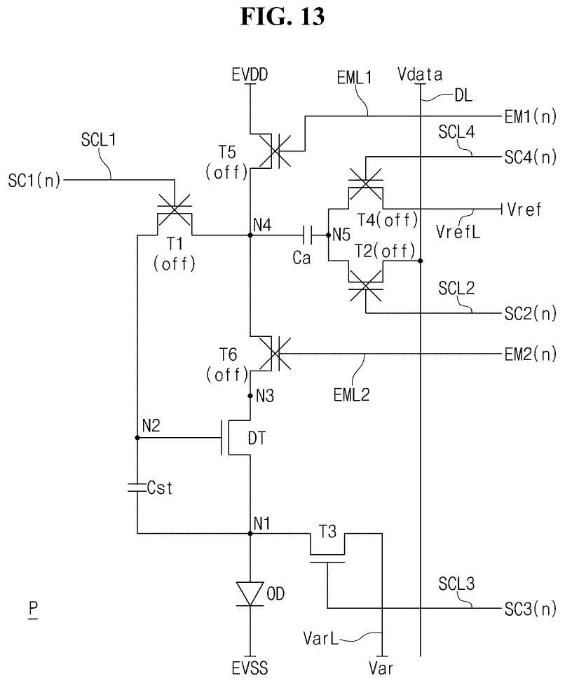

FIG. 12 is a timing chart schematically illustrating driving signals for driving a pixel according to a first example of a second embodiment of the present disclosure. FIG. 13 is a view illustrating operating states of elements within a pixel in an anode reset period in driving using the driving signals of FIG. 12.

In the following description, detailed explanations of components identical to or similar to those of the first embodiment described above can be omitted or may be briefly provided.

Similar to the first embodiment, in this embodiment, the sampling period Tsp for the threshold voltage (Vth) of the driving transistor DT can be set to a considerably long time, separated from the data writing period Tw. Accordingly, the threshold voltage (Vth) of the driving transistor DT can be sufficiently sampled during the sampling operation, so that an error component of the threshold voltage (Vth) that can occur when sampling for a short time, such as a horizontal period, can be reduced or prevented. Therefore, the compensation error of the threshold voltage can be reduced, and the threshold voltage compensation can be enhanced.

Unlike the first embodiment, in this embodiment, an anode reset period Tar that resets the voltage of the anode electrode of the light emitting diode OD can be added after the data writing period Tw. More specifically, the anode reset period Tar can be added between the data writing period Tw and the emission period Te.

In this regard, the operation in the anode reset period Tar according to the first example of this embodiment can be described with reference to FIGS. 12 and 13.

The pixel P of this embodiment can have the same structure as the pixel P of the first embodiment.

The pixel P of this embodiment can be driven similarly to the first embodiment. In this regard, referring to FIG. 12, the refresh frame FRr, which is the frame FR in which the refresh operation is performed, can be divided into the non-emission period Tne and the emission period Te.

In addition, within the non-emission period Tne, the initialization period Ti, the sampling period Tsp, and the data writing period Tw can be sequentially performed. The operations in the initialization period Ti, the sampling period Tsp, and the data writing period Tw can be performed in the same manner as in the first embodiment, and a detailed description thereof can be omitted or briefly provided.

Furthermore, in this embodiment, after the data writing period Tw and before the emission period Te, the anode reset period Tar can be defined to reset the anode electrode of the light emitting diode OD again.

Regarding the anode reset period Tar, referring to FIGS. 12 and 13, for example, the first, second, and fourth scan signals SC1(n), SC2(n), and SC4(n) can have a low level which is a turn-off level, the third scan signal SC3(n) can have a high level which is a turn-on level, and the first and second emission control signals EM1(n) and EM2(n) can have a low level which is a turn-off level.

As such, during the anode reset period Tar, the third scan signal SC3(n) can have a high-level scan pulse P3_2. The third scan signal SC3(n) can have a high-level scan pulse P3_1 before the anode reset period Tar, and this scan pulse P3_1 can be set corresponding to (or overlapping with) the initialization period Ti, the sampling period Tsp, and the data writing period Tw. Here, for convenience of explanation, the scan pulse P3_1 of the third scan signal SC3(n) set before the anode reset period Tar can be referred to as a first scan pulse P3_1, and the scan pulse P3_2 of the third scan signal SC3(n) set in the anode reset period Tar can be referred to as a second scan pulse P3_2.

In response to the scan signals SC1(n) to SC4(n) and the emission control signals EM1(n) and EM2(n), the first, second, fourth, fifth, and sixth transistors T1, T2, T4, T5, and T6 can be turned off, and the third transistor T3 can be turned on.

Accordingly, by the third transistor T3 in the turned-on state, the anode reset voltage Var can be provided to the first node N1, so that the reset of the anode electrode of the light emitting diode OD can be performed.

As described above, in the anode reset period Tar, the anode reset voltage Var can be applied to the first node N1 connected to the first electrode of the storage capacitor Cst, and the second node N2 connected to the second electrode of the storage capacitor Cst can be in an electrically floating state.

After the anode reset period Tar is completed, the emission period Te can proceed. Similar to the first embodiment, during the emission period Te, a driving current can be supplied to the light emitting diode OD to perform an emission operation.

As such, in this embodiment, the anode reset operation that resets the voltage of the anode electrode of the light emitting diode OD can be added after the data writing period Tw, and the emission period Te can be set after the anode reset period Tar.

By performing the anode reset operation before the emission operation in this way, the voltage of the first node N1, to which the anode electrode of the light emitting diode OD is connected, can be stably maintained at the anode reset voltage Var before the emission operation. Accordingly, the light emitting diode OD can emit light normally during the emission period Te.

In this regard, the voltage of the first node N1 may not be maintained but can fluctuate due to a leakage current, etc., after the data writing and before the emission. For example, the voltage of the first node N1 can increase. If the voltage of the first node N1 increases in this way, the light emitting diode OD can emit light rapidly when the emission period Te begins, which can cause a problem such as a flicker.

However, in this embodiment, by setting the anode reset period Tar after the data writing and before the emission, the voltage of the first node N1 can be stably maintained at the anode reset voltage Var. Accordingly, when the emission period Te begins, the light emitting diode OD can emit light normally, so that an image quality defect such as a flicker caused by the voltage fluctuation of the first node N1 can be reduced or prevented.

In the above first example of this embodiment, when additionally setting the anode reset period Tar, the third transistor T3 can be turned on and the other transistors T1, T2, T4, T5 and T6 can be turned off.

Examples of driving methods different from the first example can be discussed below.

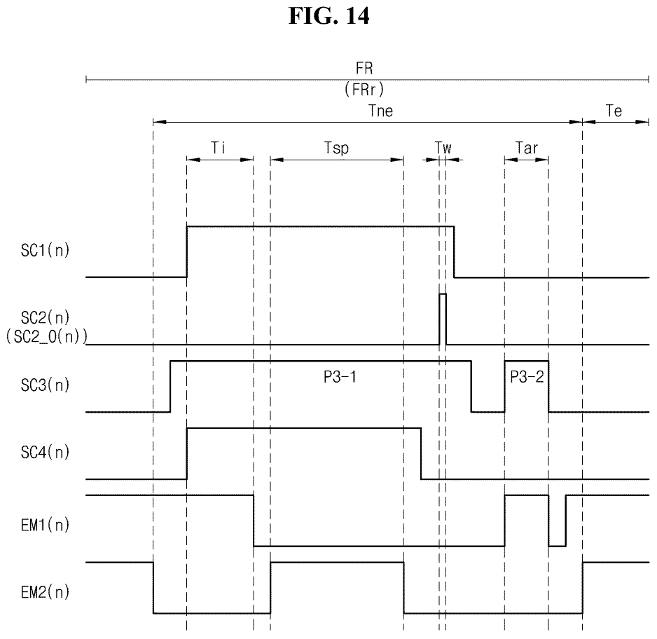

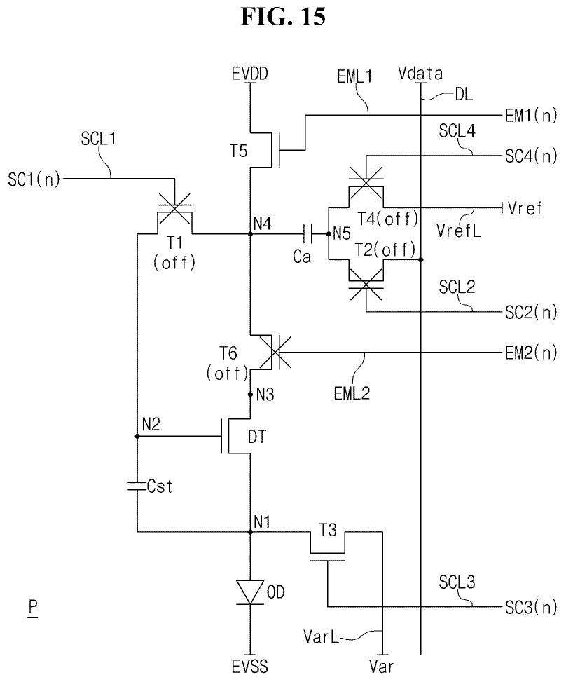

FIG. 14 is a timing chart schematically illustrating driving signals for driving a pixel according to a second example of the second embodiment of the present disclosure. FIG. 15 is a view illustrating operating states of elements within a pixel in an anode reset period in driving using the driving signals of FIG. 14.

Regarding driving the pixel P in the anode reset period Tar of the second example of this embodiment, referring to FIGS. 14 and 15, the first, second, and fourth scan signals SC1(n), SC2(n), and SC4(n) can have a low level, which is a turn-off level, the third scan signal SC3(n) can have a high level, which is a turn-on level, the first emission control signal EM1(n) can have a high level, which is a turn-on level, and the second emission control signal EM2(n) can have a low level which is a turn-off level.

As such, during the anode reset period Tar, the third scan signal SC3(n) can have a high-level scan pulse P3_2. In addition, during the anode reset period Tar, the first emission control signal EM1(n) can have a high-level scan pulse.

In response to the scan signals SC1(n) to SC4(n) and the emission control signals EM1(n) and EM2(n), the first, second, fourth, and sixth transistors T1, T2, T4, and T6 can be turned off, and the third and fifth transistors T3 and T5 can be turned on.

Accordingly, the anode reset voltage Var can be provided to the first node N1 by the third transistor T3 in the turned-on state, thereby resetting the anode electrode of the light emitting diode OD.

Furthermore, the high-potential driving voltage EVDD can be provided to the fourth node N4 by the fifth transistor T5 in the turned-on state. Accordingly, the fourth node N4 can be pre-charged with the high-potential driving voltage EVDD.

As described above, in the anode reset period Tar, the anode reset voltage Var can be applied to the first node N1 connected to the first electrode of the storage capacitor Cst, and the second node N2 connected to the second electrode of the storage capacitor Cst can be in an electrically floating state.

After the anode reset period Tar is completed, the emission period Te can proceed. Similar to the first embodiment, during the emission period Te, a driving current can be supplied to the light emitting diode OD to perform an emission operation.

As such, similar to the first example, in the second example of this embodiment, the anode reset operation for resetting the voltage of the anode electrode of the light emitting diode OD can be added after the data writing period Tw, and the emission period Te can be set after the anode reset period Tar.

By performing the anode reset operation before the emission operation in this way, the voltage of the first node N1, to which the anode electrode of the light emitting diode OD is connected, can be stably maintained at the anode reset voltage Var before the emission operation. Accordingly, the light emitting diode OD can normally emit light during the emission period Te.

In addition, unlike the first example, in the second example of this embodiment, the fifth transistor T5 can be driven in a turn-on state during the anode reset period Tar to pre-charge the fourth node N4.

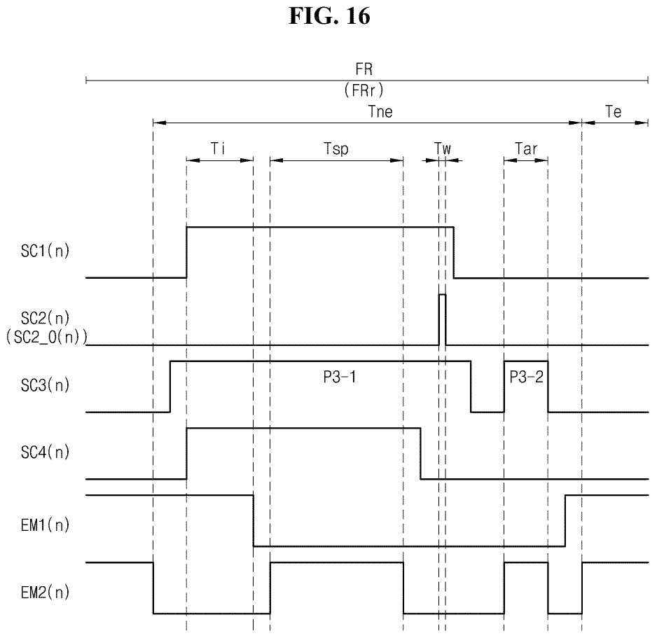

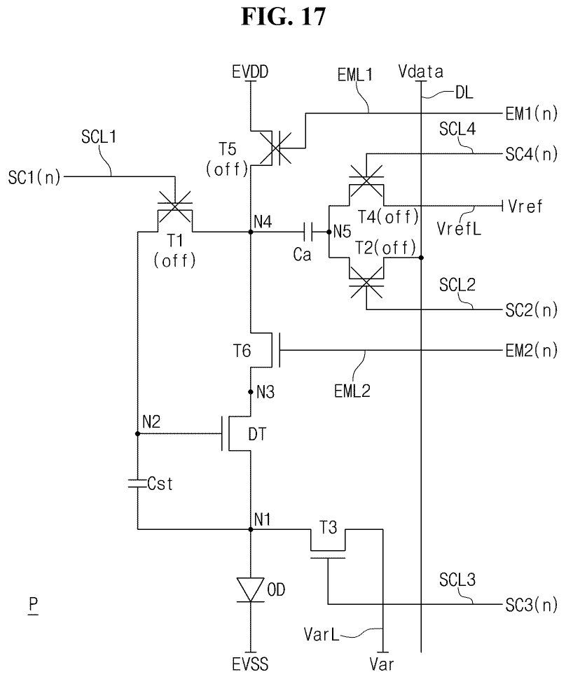

FIG. 16 is a timing view schematically illustrating driving signals for driving a pixel according to a third example of the second embodiment of the present disclosure. FIG. 17 is a view illustrating operating states of elements within a pixel during an anode reset period in driving using the driving signals of FIG. 16.

Regarding driving the pixel P in the anode reset period Tar of the third example of this embodiment, referring to FIGS. 16 and 17, the first, second, and fourth scan signals SC1(n), SC2(n), and SC4(n) can have a low level, which is a turn-off level, the third scan signal SC3(n) has a high level, which is a turn-on level, the first emission control signal EM1(n) can have a low level, which is a turn-off level, and the second emission control signal EM2(n) can have a high level which is a turn-on level.

As such, during the anode reset period Tar, the third scan signal SC3(n) can have a high-level scan pulse P3_2. In addition, during the anode reset period Tar, the second emission control signal EM2(n) can have a high-level scan pulse.

In response to the scan signals SC1(n) to SC4(n) and the emission control signals EM1(n) and EM2(n), the first, second, fourth, and fifth transistors T1, T2, T4, and T5 can be turned off, and the third and sixth transistors T3 and T6 can be turned on.

Accordingly, the anode reset voltage Var can be provided to the first node N1 by the third transistor T3 in the turned-on state, thereby resetting the anode electrode of the light emitting diode OD.

Furthermore, the fourth node N4 can be electrically short-circuited to the third node N3 by the sixth transistor T6 in the turned-on state. Accordingly, the fourth node N4 can be pre-charged with the voltage of the third node N3.

As described above, in the anode reset period Tar, the anode reset voltage Var can be applied to the first node N1 connected to the first electrode of the storage capacitor Cst, and the second node N2 connected to the second electrode of the storage capacitor Cst can be in an electrically floating state.

After the anode reset period Tar is completed, the emission period Te can proceed. Similar to the first embodiment, during the emission period Te, a driving current can be supplied to the light emitting diode OD to perform an emission operation.

As such, similar to the first example, in the third example of this embodiment, the anode reset operation for resetting the voltage of the anode electrode of the light

emitting diode OD can be added after the data writing period Tw, and the emission period Te can be set after the anode reset period Tar.

By performing the anode reset operation before the emission operation in this way, the voltage of the first node N1, to which the anode electrode of the light emitting diode OD is connected, can be stably maintained at the anode reset voltage Var before the emission operation. Accordingly, the light emitting diode OD can emit light normally during the emission period Te.

In addition, unlike the first and second examples, in the third example of this embodiment, the sixth transistor T6 can be driven in a turn-on state during the anode reset period Tar to pre-charge the fourth node N4.

### Third Embodiment

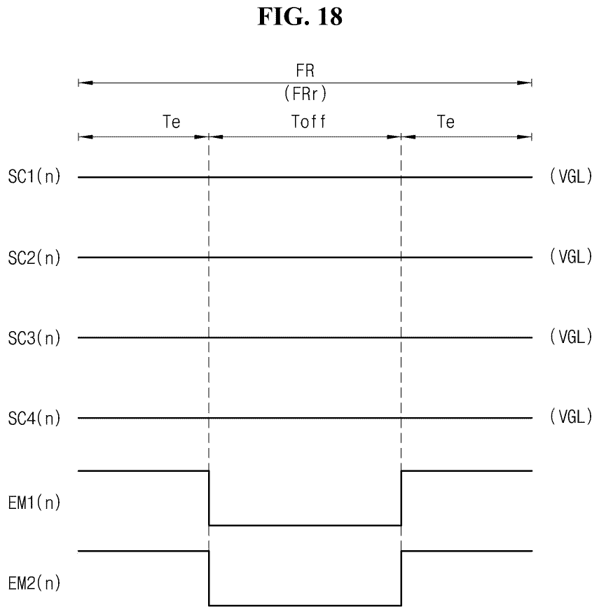

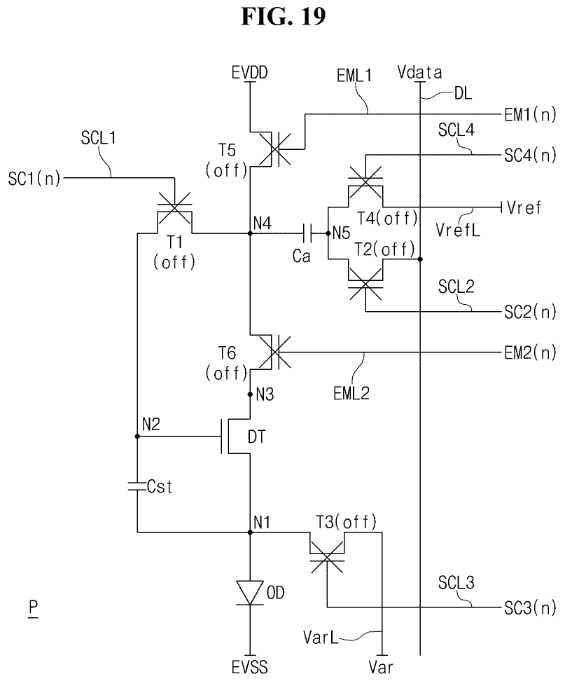

FIG. 18 is a timing view schematically illustrating driving signals for driving a pixel according to a first example of a third embodiment of the present disclosure. FIG. 19 is a view illustrating operating states of elements within a pixel during an emission-off period in driving using the driving signals of FIG. 18.

In the following description, detailed explanations of components identical to or similar to those of the first and second embodiments described above can be omitted or briefly provided.

Similar to the first and second embodiments, in this embodiment, the sampling period (Tsp of FIG. 4) for the threshold voltage (Vth) of the driving transistor DT can be set to a considerably long time, separated from the data writing period (Tw of FIG. 4). Accordingly, the threshold voltage (Vth) of the driving transistor DT can be sufficiently sampled during the sampling operation, so that an error component of the threshold voltage (Vth) that can occur when

sampling for a short time, such as a horizontal period, can be reduced or prevented. Therefore, the compensation error of the threshold voltage can be reduced, and the threshold voltage compensation can be enhanced.

In the display apparatus, an emission-off operation that turns off the emission of the light emitting diode OD can be performed in some cases. In this regard, after the data writing, the emission operation can be performed, then the emission operation can be turned off for a certain period of time, and then the emission operation can be performed again. For example, the light emitting diode OD can be turned off during a blank period between adjacent frames to be in a non-emission state.

In this regard, with reference to FIGS. 18 and 19, an operation in an emission-off period Toff according to the first example of this embodiment can be described.

In FIG. 18, for convenience of explanation, the driving signals in the emission period Te and the emission-off period Toff are illustrated by way of example. In addition, a case where the first to fourth scan signals SC1(n) to SC4(n) are all at a low level (i.e., at a gate low voltage VGL) in the emission period Te and the emission-off period Toff is illustrated as an example.

The pixel P of this embodiment can be configured with the same structure as the pixel P of the first or second embodiment.

The pixel P of this embodiment can be driven similarly to the first or second embodiment. In this regard, as described in the first or second embodiment, the refresh frame FRr, which is the frame FR in which the refresh operation is performed, can be divided into the non-emission period (Tne of FIG. 4) and the emission period Te. In addition, within the non-emission period (Tne of FIG. 4), the initialization period (Ti of FIG. 4), the sampling period (Tsp of FIG. 4), and the data writing period (Tw of FIG. 4) can be sequentially performed. Furthermore, as in the second embodiment, the anode reset period (Tar of FIG. 12) can be additionally set.

The operations in the initialization period, the sampling period, the data writing period, and the anode reset period can be performed in the same manner as in the first or second embodiment, and a detailed description thereof can be omitted or briefly provided.

Furthermore, in this embodiment, for example, the emission-off period Toff can be set after the emission period Te or between adjacent emission periods Te.

Regarding the emission-off period Toff, referring to FIGS. 18 and 19, for example, the first, second, third, and fourth scan signals SC1(n), SC2(n), SC3(n), and SC4(n) can all have a low level, which is a turn-off level, and the first and second emission control signals EM1(n) and EM2(n) can all have a low level which is a turn-off level.

In response to the scan signals SC1(n) to SC4(n) and the emission control signals EM1(n) and EM2(n), the first to sixth transistors T1 to T6 can all be turned off.

Accordingly, by the fifth and sixth transistors T5 and T6 in the turned-off state, the driving transistor DT and the terminal of the high-potential driving voltage EVDD can be electrically disconnected from each other, so that no current path is formed, and the high-potential driving voltage EVDD is not supplied to the driving transistor DT.

Thus, the driving transistor DT can be substantially turned off, so that no emission current is generated. Consequently, no emission current is supplied to the light emitting diode OD, and the light emitting diode OD can be turned off.

As such, during the emission-off period Toff, the fifth and sixth transistors T5 and T6 can be turned off, thereby disconnecting the driving current path, thereby enabling the emission-off operation of the light emitting diode OD. Since the both transistors T5 and T6 controlling emission are driven in the turned-off state, the driving current path can be doubly blocked, ensuring reliability of the emission-off operation.

After the emission-off period Toff is completed, the emission period Te can begin again.

In the above first example of this embodiment, when setting the emission-off period Toff, both fifth and sixth transistors T5 and T6 controlling emission can be turned off.

Examples of driving methods different from the first example can be discussed below.

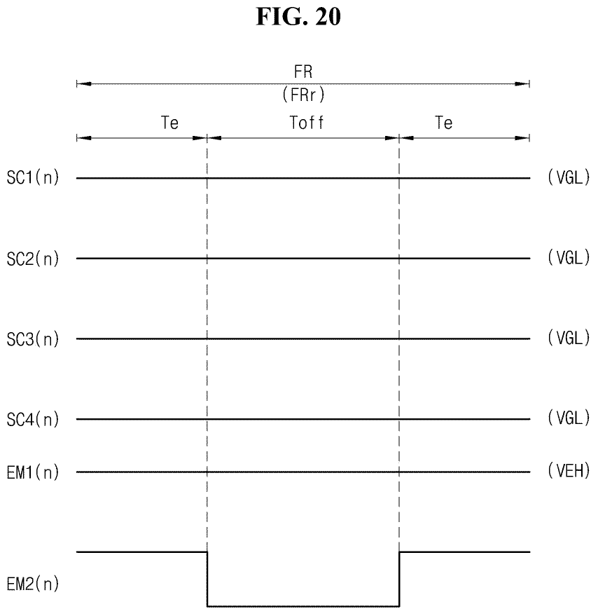

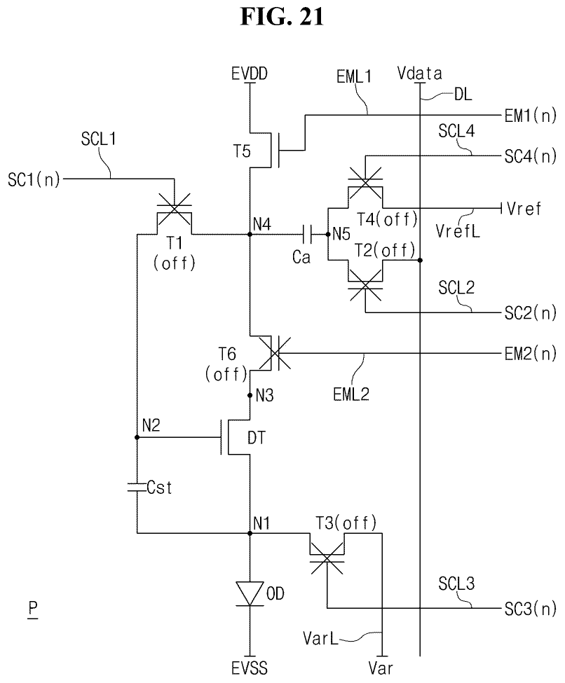

FIG. 20 is a timing chart schematically illustrating driving signals for driving a pixel according to a second example of the third embodiment of the present disclosure. FIG. 21 is a view illustrating operating states of elements within a pixel in an emission-off period in driving using the driving signals of FIG. 20.

Regarding driving the pixel P in the emission-off period Toff of the second example of this embodiment, referring to FIGS. 20 and 21, the first, second, third, and fourth scan signals SC1(n), SC2(n), SC3(n), and SC4(n) can all have a low level, which is a turn-off level, the first emission control signal EM1(n) can have a high level (i.e., a gate high voltage VEH), which is a turn-on level, and the second emission control signal EM2(n) can have a low level which is a turn-off level.

In response to the scan signals SC1(n) to SC4(n) and the emission control signals EM1(n) and EM2(n), the first to fourth transistors T1 to T4 and the sixth transistor T6 can all be turned off, and the fifth transistor T5 can be turned on.

Accordingly, by the sixth transistor T6 in the turned-off state, the driving transistor DT and the terminal of the high-potential driving voltage EVDD can be electrically disconnected from each other, so that no current path is formed, and the high-potential driving voltage EVDD is not supplied to the driving transistor DT.

Thus, the driving transistor DT can be substantially turned off, so that no emission current is generated. Consequently, no emission current is supplied to the light emitting diode OD, and the light emitting diode OD can be turned off.

As such, during the emission-off period Toff, the sixth transistor T6 can be turned off, thereby disconnecting the driving current path, thereby enabling the emission-off operation of the light emitting diode OD.

After the emission-off period Toff is completed, the emission period Te can be performed again.

As such, unlike the first example, in the second example of this embodiment, the fifth transistor T5 can maintain the turn-on state and the sixth transistor T6 can be switched to the turn-off state. In this case, in the first emission control signal EM1(n) applied to the fifth transistor T5, a toggle in which a voltage level is switched during the emission-off period Toff is not generated, so that an increase in power consumption due to the toggle of signal can be reduced. Accordingly, compared to the first example, the power consumption during the emission-off operation of the second example can be reduced, resulting in low-power driving.

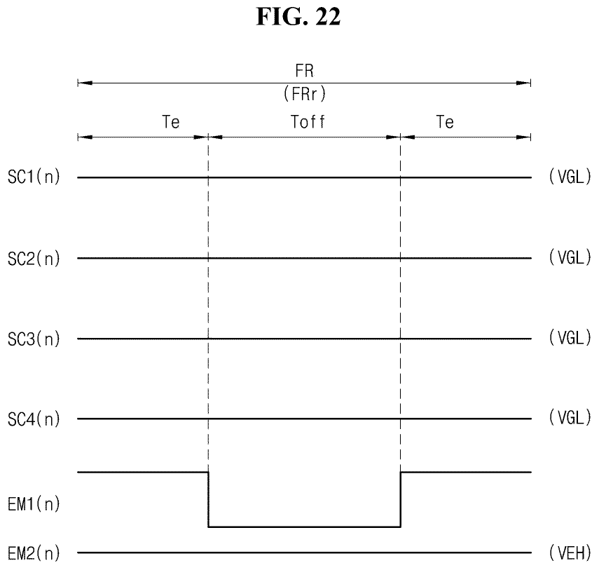

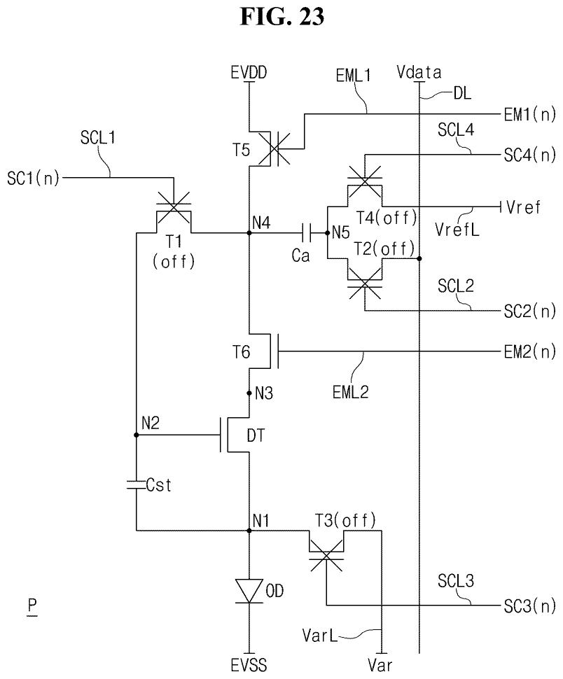

FIG. 22 is a timing chart schematically illustrating driving signals for driving a pixel according to a third example of the third embodiment of the present disclosure. FIG. 23 is a view illustrating operating states of elements within a pixel in an emission-off period in driving using the driving signals of FIG. 22.

Regarding driving the pixel P in the emission-off period Toff of the third example of this embodiment, referring to FIGS. 22 and 23, the first, second, third, and fourth scan signals SC1(n), SC2(n), SC3(n), and SC4(n) can all have a low level, which is a turn-off level, the first emission control signal EM1(n) can have a low level, which is a turn-off level, and the second emission control signal EM2(n) can have a high level which is a turn-on level (i.e., a gate high voltage VEH).

In response to the scan signals SC1(n) to SC4(n) and the emission control signals EM1(n) and EM2(n), the first to fifth transistors T1 to T5 can all be turned off, and the sixth transistor T6 can be turned on.

Accordingly, by the fifth transistor T5 in the turned-off state, the driving transistor DT and the terminal of the high-potential driving voltage EVDD terminal can be electrically disconnected from each other, so that no current path is formed, and the high-potential driving voltage EVDD is not supplied to the driving transistor DT.

Thus, the driving transistor DT can be substantially turned off, so that no emission current is generated. Consequently, no emission current is supplied to the light emitting diode OD, and the light emitting diode OD can be turned off.

As such, during the emission-off period Toff, the fifth transistor T5 can be turned off, thereby disconnecting the driving current path, thereby enabling the emission-off operation of the light emitting diode OD.

After the emission-off period Toff is completed, the emission period Te can begin again.

In this way, unlike the first and second examples, in the third example of this embodiment, the sixth transistor T6 can maintain the turn-on state and the fifth transistor T5 can be switched to the turn-off state. In this case, in the second emission control signal EM2(n) applied to the sixth transistor T6, a toggle in which a voltage level is switched during the emission-off period Toff is not generated, so that an increase in power consumption due to the toggle of signal can be reduced. Accordingly, compared to the first example, the power consumption during the emission-off operation of the third example can be reduced, resulting in low-power operation.

### Fourth Embodiment

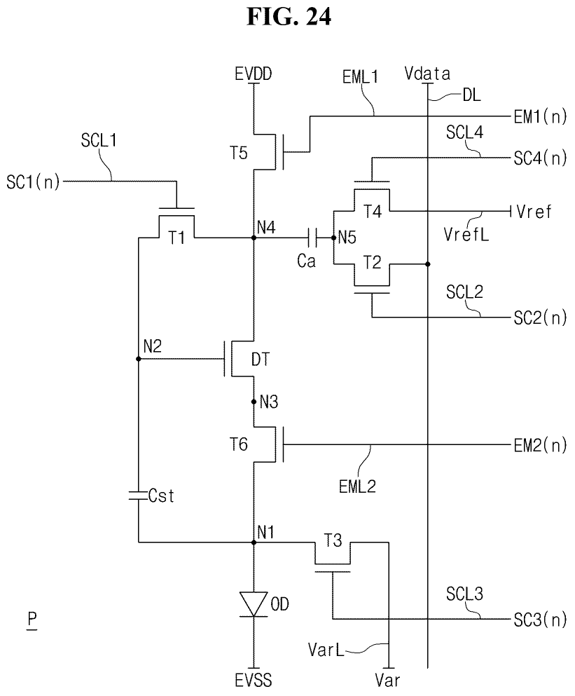

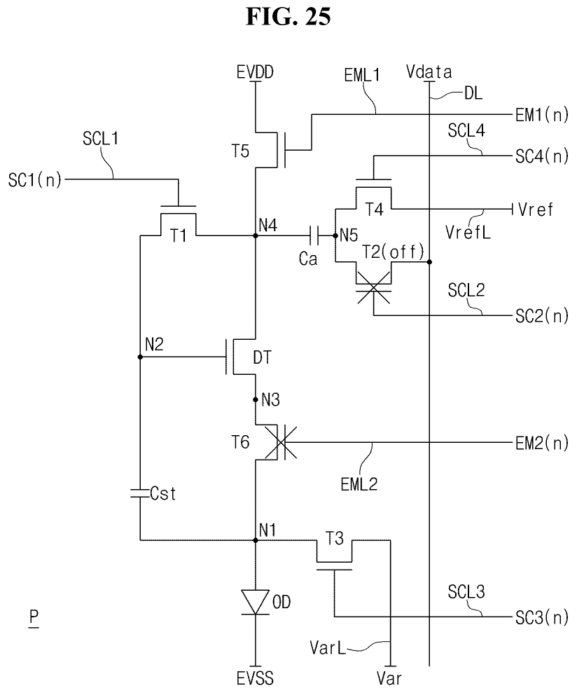

FIG. 24 is a view schematically illustrating an example of a pixel according to a fourth embodiment of the present disclosure. FIGS. 25 to 28 are views illustrating operating states of elements within a pixel in an initialization period, a sampling period, a data writing period, and an emission period in driving according to the fourth embodiment of the present disclosure.

In the following description, detailed explanations of components identical to or similar to those of the first embodiment described above can be omitted or briefly provided.

Referring to FIG. 24, similar to the first embodiment, in this embodiment, the sampling period (Tsp of FIG. 4) for the threshold voltage (Vth) of the driving transistor DT can be set to a considerably long time, separated from the data writing period (Tw of FIG. 4). Accordingly, the threshold voltage (Vth) of the driving transistor DT can be sufficiently sampled during the sampling operation, so that an error component of the threshold voltage (Vth) that can occur when sampling for a short time, such as a horizontal period, can be reduced or prevented. Therefore, the compensation error of the threshold voltage can be reduced, and the threshold voltage compensation can be enhanced.

Unlike the first embodiment, in the pixel P of this embodiment, the sixth transistor T6 to which the second emission control signal EM2(n) is applied can be configured to be connected between the driving transistor DT and the light emitting diode OD.

In this regard, the sixth transistor T6 can include a second electrode (or drain electrode) connected to the driving transistor DT at the third node N3, a first electrode (or source electrode) connected to the light emitting diode OD at the first node N1, and a gate electrode receiving the second emission control signal EM2(n).

With the sixth transistor T6 arranged as described above, the second electrode of the driving transistor DT can be connected to the fourth node N4.

The pixel P configured as described above can be driven similarly to the first embodiment. For example, within the non-emission period (Tne of FIG. 4), the initialization period (Ti of FIG. 4), the sampling period (Tsp of FIG. 4), and the data writing period (Tw of FIG. 4) can be sequentially performed, followed by the emission period (Te of FIG. 4).

In this regard, referring to FIG. 25, for example, in the initialization period, in response to the scan signals SC1(n) to SC4(n) and the emission control signals EM1(n) and EM2(n), the first transistor T1, the third transistor T3, the fourth transistor T4, and the fifth transistor T5 can be turned on, and the second transistor T2 and the sixth transistor T6 can be turned off.

Accordingly, the initialization i.e., the anode reset of the anode electrode of the light emitting diode OD can be performed. In addition, the voltage of the gate electrode of the driving transistor DT can be initialized, and the voltage stored in the storage capacitor Cst and the voltage stored in the pumping capacitor Ca can be initialized.

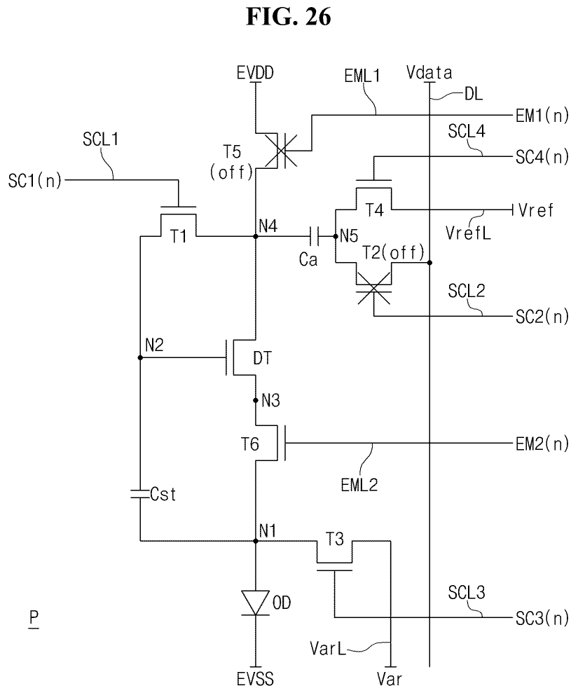

Next, referring to FIG. 26, in the sampling period, in response to the scan signals SC1(n) to SC4(n) and the emission control signals EM1(n) and EM2(n), the first transistor T1, the third transistor T3, the fourth transistor T4, and the sixth transistor T6 can be turned on, and the second transistor T2 and the fifth transistor T5 can be turned off.

By the first and sixth transistors T1 and T6 in the turned-on state, the driving transistor DT can implement a diode-connection state in which the gate electrode and the drain electrode of the driving transistor DT are electrically short-circuited. At this time, the third transistor T3 can be turned on, and as a result, a current path can be formed along the third transistor T3, the driving transistor DT, the sixth transistor T6, and the first transistor T1.

The anode reset voltage Var and the threshold voltage (Vth) can be charged and stored in the storage capacitor Cst at the second node N2 to which the gate electrode of the driving transistor DT is connected.

The sampling period can be set to a considerably long time, separated from the data writing period, so that the threshold voltage (Vth) of the driving transistor DT can be sufficiently sampled during the sampling operation.

Accordingly, an error component of the threshold voltage (Vth) that can occur when sampling for a short time, such as a horizontal period, can be reduced or prevented, so that the error of the threshold voltage compensation can be reduced and the threshold voltage compensation can be enhanced, and as a result, the image quality of the display apparatus can be improved.

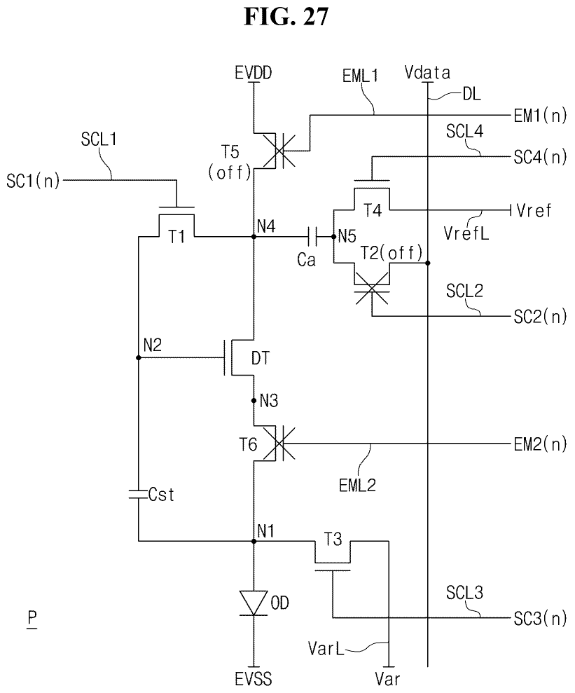

Next, referring to FIG. 27, in the data writing period, in response to the scan signals SC1(n) to SC4(n) and the emission control signals EM1(n) and EM2(n), the first transistor T1, the second transistor T2, and the third transistor T3 can be turned on, and the fourth transistor T4, the fifth transistor T5, and the sixth transistor T6 can be turned off.

Accordingly, the data voltage Vdata can be provided to the fifth node N5 by the second transistor T2 in the turned-on state, and the data voltage Vdata can be reflected to the fourth node N4 through the pumping capacitor Ca. The voltage reflected at the fourth node N4 can be transmitted to the second node N2 through the first transistor T1, and can be reflected in the voltage of the second node N2 i.e., the voltage of the gate electrode of the driving transistor DT.

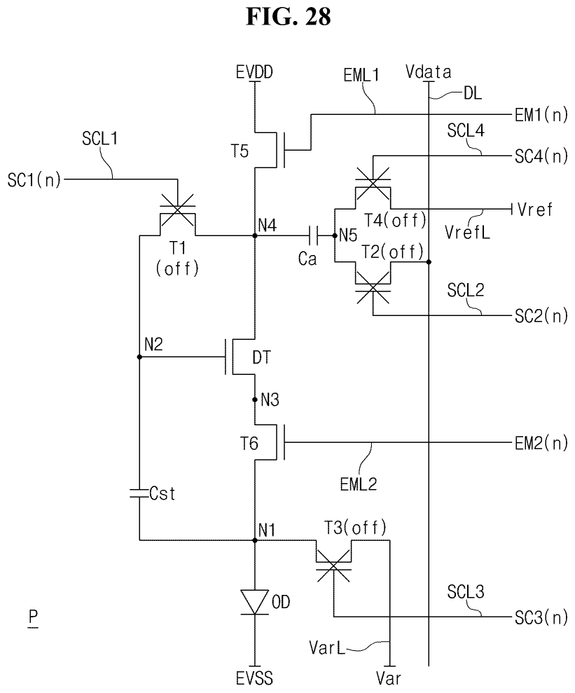

Next, referring to FIG. 28, after the data writing period Tw is completed, a driving current can be supplied to the light emitting diode OD during the emission period Te, thereby performing an emission operation.

In response to the scan signals SC1(n) to SC4(n) and the emission control signals EM1(n) and EM2(n), the first transistor T1 to the fourth transistor T4 can all be turned off, and the fifth and sixth transistors T5 and T6 can all be turned on.

Accordingly, through the turned-on fifth and sixth transistors T5 and T6, a current path can be formed from the terminal of the high-potential driving voltage EVDD to the terminal of the low-potential driving voltage EVSS. At this time, the driving transistor DT can be turned on according to the voltage of the second node N2 i.e., the gate electrode of the driving transistor DT to which the data voltage Vdata is reflected, so that the driving current corresponding to the data voltage Vdata can be provided to the light emitting diode OD, and the light emitting diode OD can emit light.

### Fifth Embodiment

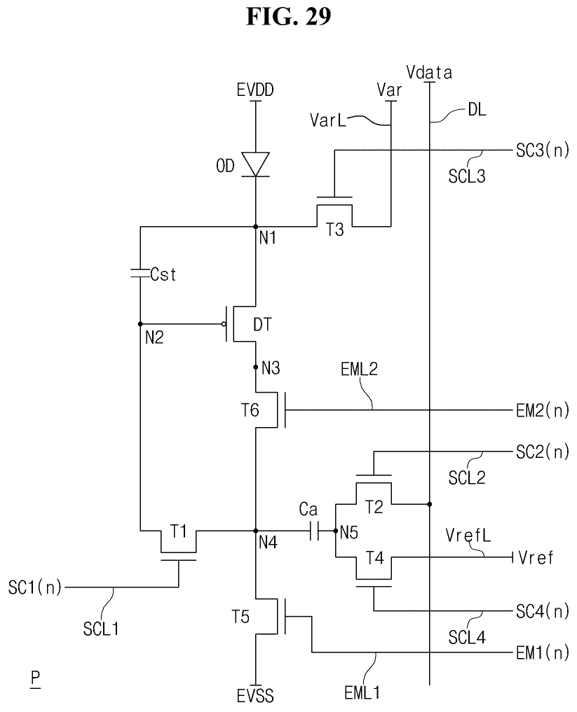

FIG. 29 is a view schematically illustrating an example of a pixel according to a fifth embodiment of the present disclosure.

In the following description, detailed explanations of components identical or similar to those of the first embodiment described above can be omitted or briefly provided.

Referring to FIG. 29, similar to the first embodiment, in this embodiment, the sampling period (Tsp of FIG. 4) for the threshold voltage (Vth) of the driving transistor DT can be set to a considerably long time, separated from the data writing period (Tw of FIG. 4). Accordingly, the threshold voltage (Vth) of the driving transistor DT can be sufficiently sampled during the sampling operation, so that an error component of the threshold voltage (Vth) that can occur when sampling for a short time, such as a horizontal period, can be reduced or prevented. Therefore, the compensation error of threshold voltage can be reduced, and the threshold voltage compensation can be enhanced.

Unlike the first embodiment, in the pixel P of this embodiment, the driving transistor DT can be configured as a P-type transistor. Accordingly, the circuit structure of the pixel P of this embodiment can have a form reversed from the circuit structure of the pixel P of the first embodiment.

In this regard, for example, the P-type driving transistor DT can be connected to the light emitting diode OD at the first node N1, more specifically, to the cathode electrode (or first electrode) of the light emitting diode OD. In this case, the anode electrode (or second electrode) of the light emitting diode OD can be configured to receive the high-potential driving voltage EVDD.

The first transistor T1 to the sixth transistor T6 within the pixel P can be configured as N-type transistors, but not limited thereto.

In this case, the connection relationship among the driving transistor DT, the first to sixth transistors T1 to T6, the storage capacitor Cst, and the pumping capacitor Ca can be similar to the connection relationship in the first embodiment.

For example, the first transistor T1 can be connected between the second node N2 and the fourth node T4. The second transistor T2 can be connected between the fifth node N5 and the data line DL. The fourth transistor T4 can be connected between the fifth node N5 and the reference voltage line VrefL. The third transistor T3 can be connected between the first node N1 and the reset voltage line VarL.

The fifth transistor T5 can be connected to the fourth node N4 and can receive the low-potential driving voltage EVSS. The sixth transistor T6 can be connected between the third node N3 and the fourth node N4.

The storage capacitor Cst can be connected between the first node N1 and the second node N2. The pumping capacitor Ca can be connected between the fourth node N4 and the fifth node N5.

As described above, in the embodiments of the present disclosure, the sampling period for the threshold voltage of the driving transistor can be set to a considerably long time, separated from the data writing period.

The threshold voltage of the driving transistor can be sufficiently sampled during the sampling operation, so that an error component of the threshold voltage that can occur when sampling for a short time, such as a horizontal period, can be reduced or prevented.

Therefore, an error of the threshold voltage compensation can be reduced, and thus the threshold voltage compensation can be improved, and, consequently, the image quality of the display apparatus can be enhanced.

Further, the anode reset period can be added after the data writing period, to reset the voltage of the anode electrode of the light emitting diode. Accordingly, the anode reset voltage can be maintained stably, the light emitting diode can emit light normally during the emission period.

Furthermore, during the emission-off period, at least one of the two transistors controlling the emission can be turned off. Here, when the two transistors are all driven in the turned-off state, the path of the driving current can be doubly blocked, ensuring the reliability of the emission-off operation. In addition, when either one of the two transistors is driven in the turned-off state, the increase in power consumption due to the toggling of the signal applied to the turned-on transistor can be reduced, enabling low-power operation.

It will be apparent to those skilled in the art that various modifications and variation can be made in the present disclosure without departing from the spirit or scope of the disclosure. Thus, it is intended that the present disclosure cover the modifications and variations of this disclosure provided they come within the scope of the appended claims and their equivalents.

What is claimed is:

1. A display apparatus, comprising:
a display panel including a pixel; and
a light emitting diode, and a plurality of transistors and first and second capacitors which are configured to be electrically connected to the light emitting diode, in the pixel,
wherein the plurality of transistors include:
a driving transistor connected to an anode electrode of the light emitting diode at a first node;
a first transistor connected between a second node and a fourth node, the second node being a node to which a gate electrode of the driving transistor is connected;
a second transistor connected between a data line and a fifth node;
a third transistor connected to the first node and configured to receive an anode reset voltage;
a fourth transistor connected to the fifth node and configured to receive a reference voltage;
a first emission control transistor connected to the fourth node and configured to receive a high-potential driving voltage; and
a second emission control transistor connected to the fourth node and connected to the driving transistor at a third node, and
wherein the first capacitor is connected between the first and second nodes, and the second capacitor is connected between the fourth and fifth nodes.

2. The display apparatus of claim 1, wherein in a sampling period for sampling a threshold voltage of the driving transistor, the first, third, and fourth transistors and the second emission control transistor are configured to be turned on, and the second transistor and the first emission control transistor are configured to be turned off.

3. The display apparatus of claim 2, wherein in a data writing period after the sampling period, the first and second transistors are configured to be turned on, and the fourth transistor and the first and second emission control transistors are configured to be turned off.

4. The display apparatus of claim 3, wherein in the data writing period, the third transistor is configured to be turned on.

5. The display apparatus of claim 2, wherein in an initialization period before the sampling period, the first, third, and fourth transistors and the first emission control transistor are configured to be turned on, and the second transistor and the second emission control transistor are configured to be turned off.

6. The display apparatus of claim 3, wherein in an anode reset period after the data writing period, the third transistor is configured to be turned on.

7. The display apparatus of claim 6, wherein in the anode reset period, the first, second, and fourth transistors, and the first and second emission control transistors are configured to be turned off.

8. The display apparatus of claim 6, wherein in the anode reset period, the first emission control transistor is configured to be turned on, and the first, second, and fourth transistors, and the second emission control transistor are configured to be turned off.

9. The display apparatus of claim 6, wherein in the anode reset period, the second emission control transistor is configured to be turned on, and the first, second, and fourth transistors, and the first emission control transistor are configured to be turned off.

10. The display apparatus of claim 3, wherein in an emission period after the data writing period, the first to fourth transistors are configured to be turned off, and the first and second emission control transistors are configured to be turned on.

11. The display apparatus of claim 6, wherein in an emission period after the anode reset period, the first to fourth transistors are configured to be turned off, and the first and second emission control transistors are configured to be turned on.

12. The display apparatus of claim 10, wherein in an emission-off period after the emission period, at least one of the first and second emission control transistors is configured to be turned off.

13. A display apparatus, comprising:
a display panel including a pixel;
a light emitting diode in the pixel;
a driving transistor connected to an anode electrode of the light emitting diode at a first node;
a first transistor connected between a second node and a fourth node, the second node being a node to which a gate electrode of the driving transistor is connected;
a second transistor connected between a data line and a fifth node;
a third transistor connected to the first node and configured to receive an anode reset voltage;
a fourth transistor connected to the fifth node and configured to receive a reference voltage;
a first emission control transistor connected to the fourth node and connected to the driving transistor at a third node;
a storage capacitor connected between the first and second nodes; and
a pumping capacitor connected between the fourth and fifth nodes,
wherein in a sampling period, the anode reset voltage and a threshold voltage of the driving transistor are configured to be sampled and reflected to the second node, and
wherein in a data writing period after the sampling period, a data voltage is configured to be reflected to the second node.

14. The display apparatus of claim 13, further comprising a second emission control transistor connected to the fourth node and configured to receive a high-potential driving voltage,
wherein in the sampling period, the first, third, and fourth transistors and the first emission control transistor are configured to be turned on, and the second transistor and the second emission control transistor are configured to be turned off.

15. The display apparatus of claim 14, wherein in the data writing period, the first, second, and third transistors are configured to be turned on, and the fourth transistor and the first and second emission control transistors are configured to be turned off.

16. The display apparatus of claim 13, wherein in an anode reset period after the data writing period, the third transistor is configured to be turned on, and the anode reset voltage is provided to the first node.

17. The display apparatus of claim 14, wherein in an emission period after the data writing period, the first to fourth transistors are configured to be turned off, and the first and second emission control transistors are configured to be turned on.

18. The display apparatus of claim 17, wherein in an emission-off period after the emission period, at least one of the first and second emission control transistors is configured to be turned off.
